(19) United States
(12) Patent Application Publication
(10) Pub. No.: US 2018/0137584 A1
(43) Pub. Date: May 17, 2018

(54) Method and System Using Computing Applications for Mutual Benefit of Connected Parties in the Real Estate Industry

(71) Applicants: Beatty Carmichael, Vestavia Hills, AL (US); Daniel Troy Carmichael, Mountain Brook, AL (US)

(72) Inventors: Beatty Carmichael, Vestavia Hills, AL (US); Daniel Troy Carmichael, Mountain Brook, AL (US)

(21) Appl. No.: 15/810,051

(22) Filed: Nov. 11, 2017

Related U.S. Application Data
(60) Provisional application No. 62/421,134, filed on Nov. 11, 2016.
(60) Provisional application No. 62/459,761, filed on Feb. 16, 2017.

(51) Int. Cl. G06Q 50/16

(52) U.S. Cl. CPC G06Q 50/16; G06Q 10/109

(57) ABSTRACT

A method and system for connecting parties in the real estate industry comprising a first application targeted at partners and agents and a second application targeted at agents and homeowners whereby the first application and the second application work together to create benefit for all parties involved. Message alerts are generated and sent to agents and homeowners bearing the branding of the partner and agent respectively upon the occurrence of an event beneficial to said party. The second application further has a reminder utility and a directory utility for aid in the maintenance of a homeowner's home.

### CROSS-REFERENCE TO RELATED APPLICATIONS

This application claims the benefit of priority of U.S. Provisional Application No. 62421134 filed on Nov. 11, 2016 and U.S. Provisional Application No. 62459761 filed Feb. 16, 2017, the entire disclosures of which are herein incorporated by reference.

### FEDERALLY SPONSORED RESEARCH

None

### SEQUENCE LISTING

None

### FIELD OF THE INVENTION

The invention relates to a system of connecting multiple parties in business transactions through downloadable mobile applications for computing devices or mobile web applications accessed through computing devices such that the connection of the parties provides mutual benefit and/or value to the parties. The parties are tied together through business to business and business to end-consumer relationships. Specifically, the system and computer applications cater to the residential real estate industry where the main parties are mortgage/loan officers, real estate agents and homeowners or potential homeowners.

### BACKGROUND OF THE INVENTION

There is a need in the market place for enhanced methods and systems of connecting parties such that all parties benefit from the connection. In particular, loan officers, title agents and real estate agents need to be able to stay in front of their customers. Loan officers and title agents need to stay in front of real estate agents, and real estate agents need to stay in front of potential home owners. Common ways this has been achieved is by making direct intentional contact via mail, phone, attending events to meet potential clients, advertisements, email and more recently the text message with their respective potential customers. However, these avenues of contact are all manual in nature and take intentional effort by the loan officer to stay in front of real estate agents and for real estate agents to stay in front of home owners. Additionally, these methods of contact can be obtrusive and often times exasperate or frustrate individuals who are constantly solicited for business but get no benefit in return. What is needed in the art is a system and method to enhance the ability of loan officers, title agents, and real estate agents to stay in front of their respective clients while also benefitting the homeowner in an automated fashion such that they receive mutual benefit and leverage each party's connections to further broaden their footprint in the industry.

### SUMMARY OF THE INVENTION

The invention is a method and system for connecting various parties in a given industry, and more particularly the residential real estate industry, by using mobile or web based applications to give value to the parties involved in the transaction. Specifically, two applications are used to achieve this result. These two applications include a referral application and a homeowner application and are used synergistically to create value for the partner, real estate agent and the homeowner. For purposes of this application, the term “referral application” can be used interchangeably with the term “first application” and the word “homeowner application” can be used interchangeably with the term “second application”. The referral application is focused on the relationship between real estate agents and their respective vendors such as loan officers or title insurance agents hereinafter referred to as “partners”. The referral application allows for the partners to share the referral application with other partners or other agents via a text message or email. The referral application has a dashboard that allows the partners and/or agent to upload their personal information and picture, contact info and branding information such as logos and trademarks.

The homeowner application is focused on the relationship between the real estate agent and homeowners or potential homeowners. Both the referral application and the homeowner application have dashboards. The homeowner application is linked to the referral application such that the referral application allows the real estate agent to share the homeowner application with homeowners via text message on a mobile device while in the referral application. The homeowner application is accessed by the agent through the referral application dashboard.

The homeowner application provides the homeowner with a directory of pre-loaded contacts for vendors of home maintenance and repair contractor services as well as the option to create their own directory listings to be saved. The agent populates the pre-loaded contact information for vendors of home maintenance and repair services into the homeowner application for the homeowners with whom they share the homeowner application. The homeowner application also provides a reminder utility to the homeowner by prompting a homeowner to take a survey regarding home attributes unique to that homeowner's home and then outputting a customized reminder scheme to their mobile device or computer that alerts a homeowner to certain home maintenance and home repair items that come due every month. The reminder utility also allows a user to enter custom reminders whether they are home related or otherwise. The homeowner application can be shared between agent to homeowner and also between homeowner to homeowner. The homeowner application has customizable agent sponsored advertisements that show up on the homeowner application dashboard.

The referral application provides value to the partner by generating and sending email alerts to the agent when either one of two different trigger events occur. The first trigger event is when a homeowner refers their real estate agent to another potential homeowner via the homeowner application. This trigger event will prompt an email to be generated and automatically sent via the referral application to the agent alerting them to the fact that they were referred by one of their homeowners who uses the second application to another homeowner and will include information about the new homeowner. The second trigger event occurs when a new homeowner signs up on the homeowner application. This trigger event will prompt an email to be generated and automatically sent via the referral application to the agent alerting them to the fact that a new homeowner has signed up and downloaded the homeowner application. These email alerts have in their body the branding information of the partners such that the agent consistently sees the partner's picture, contact information and branding information a number of times each month. These email alerts provide advertising benefit for the partners and they also inform the agent of potential new customers by providing the contact information of the referring homeowner or of the new user or potential new user. Additionally, due to the way profit sharing can be set up at many banks or mortgage companies, senior loan officers benefit from the generation of loans by more junior loan officers. For this reason, the more senior loan officers would be incentivized to proliferate the use of the present method and system and computing applications to junior loan officers. The referral application provides further benefit and value to the partner because the referral application provides the agent with the homeowner application to proliferate to homeowners such that it allows for the agent to increase the number of homeowners as potential future clients which also could be future clients of the partner when those homeowners need a mortgage or loan for a home purchase, refinance or other financial related service or product.

The referral application in combination with the homeowner application provides value to the agent by having the agent's branding information on the dashboard of the homeowner application so that the homeowner always sees the agent when they use the homeowner application either when they access the directory of contractors or the reminder utility. In addition, the maintenance reminder emails and/or text messages generated by the homeowner application has the agent's branding information on the email and/or text message every time they are sent to the homeowner. Another benefit to the agent is that when a homeowner refers the homeowner application to another homeowner the referring homeowner will receive an email and/or text message from the agent with the agent branding information thanking the referring homeowner. A further benefit of the homeowner application is it allows an agent's homeowners to easily proliferate the homeowner application to other homeowners thereby increasing that agent's pool of potential future clients. When a homeowner shares the second application with another homeowner there is a message generated via email by the referral application to the agent indicating that the homeowner application had been shared with another homeowner and including the name of the referring homeowner, the name of the recipient homeowner of the second application, and the branding information of the vendor partner.

The homeowner application provides the homeowner with a number of benefits. First, the homeowner application provides the homeowner with a home maintenance reminder utility which provides automated email and/or text message reminders to the homeowner based on the homeowner input of a home maintenance survey and any additional custom reminders the homeowner may enter into the homeowner application. Second, the homeowner application provides the homeowner with a directory utility of recommended contractors and home maintenance vendors that are pre-loaded by the agent and also allows for a homeowner to add their own custom contacts to their homeowner application directory. Third, the homeowner application provides an extremely simple way for homeowners to refer their agent through the touch a button without needing to look up agent contact information. Fourth, the homeowner application provides the homeowner a very simple way to share the application without charge to friends or acquaintances who have need of contractors or of the home maintenance reminders.

Another benefit of both the referral application and the homeowner application is that when saved to a mobile device or smart phone as described, the user will see their sponsors photo and name as the icon for the homeowner application. For example, the homeowner will see the agent's photo and name, the agent will see the partner's photo and name, and Partners/Affiliates the corporate branding. This keeps the face and name of the sponsor agent and partner always visible to the user via the users smart phone.

### DESCRIPTION OF THE DRAWINGS

FIG. 1 is a flow chart showing the process of how the referral application and homeowner application is proliferated to partners, real estate agents and homeowners.

FIG. 2 is an expansion screenshot flowchart of the application features of the affiliate sign-up dashboard for the referral application.

FIG. 3 is an expansion screenshot flowchart of the application features of the affiliate dashboard for the referral application.

FIG. 4 is an expansion screenshot flowchart of the settings and how to use application features of the affiliate dashboard for the referral application.

FIG. 5 is an expansion screenshot flowchart of the affiliate settings module for branding, account settings and billing of the referral application.

FIG. 6 is an expansion screenshot flowchart of the partner sign up dashboard for the referral application.

FIG. 7 is an expansion screenshot flowchart of the settings and how to use application features of the partner dashboard for the referral application.

FIG. 8 is an expansion screenshot flowchart of the partner settings module for branding, account settings and billing of the referral application.

FIG. 9 is an expansion screenshot flowchart of the agent sign up dashboard for the referral application.

FIG. 10 is an expansion screenshot flowchart of the agent dashboard for the referral application and link to the homeowner application 22.

FIG. 11 is an expansion screenshot flowchart of the agent settings module for branding, account settings and billing of the referral application.

FIG. 12 is an expansion screenshot flowchart of the homeowner sign up dashboard of the homeowner application 22.

FIG. 13 is an expansion screenshot flowchart of the homeowner main dashboard of the homeowner application.

FIG. 14 is an expanded screenshot flowchart of the homeowner maintenance reminder utility of the homeowner application 22.

FIG. 15 is an expanded screenshot flowchart of the homeowner directory utility of the homeowner application.

FIG. 16 is an expanded screenshot flowchart of the agent directory utility for loading directory listings.

FIG. 17 is a flow chart showing a mobile device connected to a cloud network via mobile web application.

FIG. 18 is an expanded screen shot showing additional functionality within the directory utility.

FIG. 19 is an expanded screen shot flow chart showing additional functionality within the reminder and directory utilities.

FIG. 20 shows a companion website whereby a homeowner can activate the homeowner application.

FIG. 21 shows a mobile device with an icon that is the picture of the agent.

FIG. 22 shows a text message generated to homeowner when another homeowner refers that agent via the homeowner application.

FIG. 23 shows a generated email message to an agent from a partner.

FIG. 24 shows a generated email message to an agent from a partner.

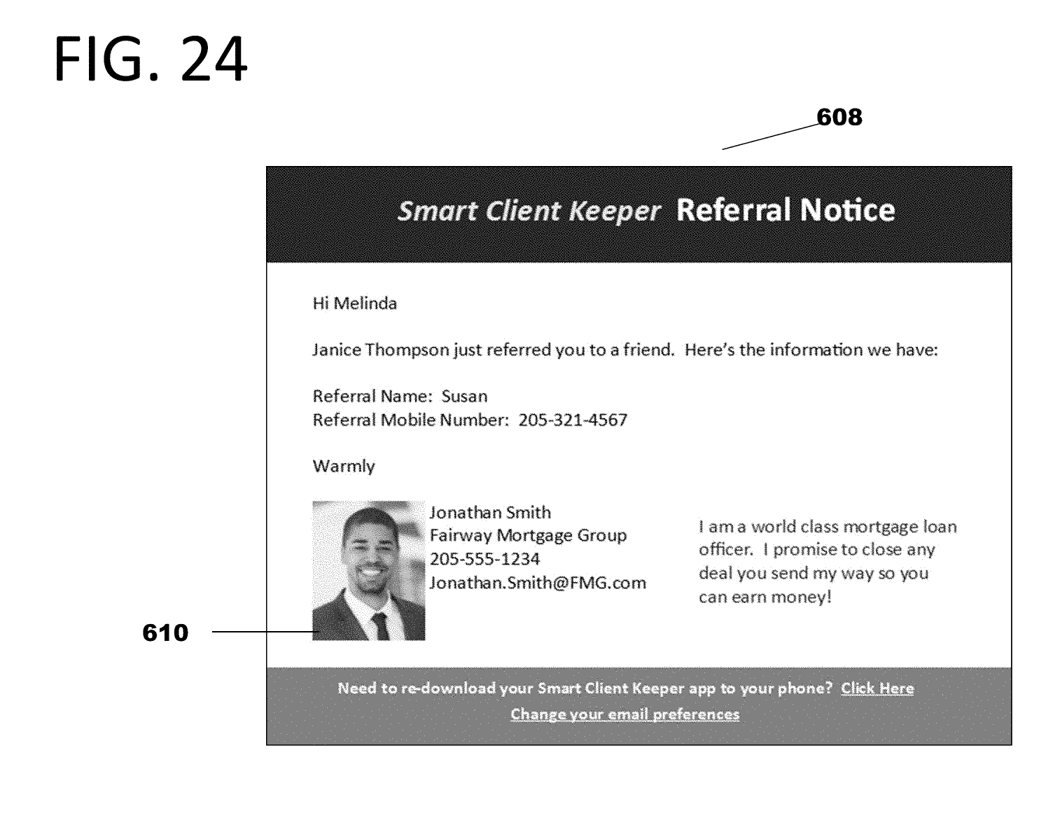

FIG. 25 shows a generated email message to a homeowner from an agent.

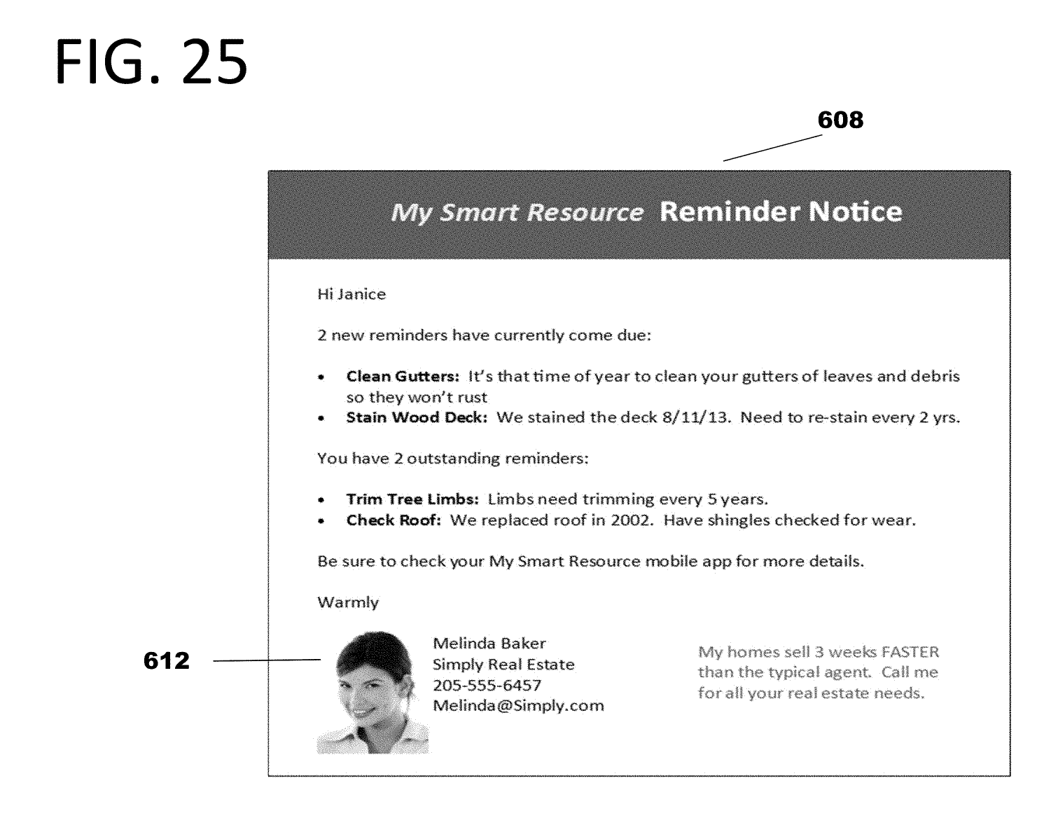

### DETAILED DESCRIPTION

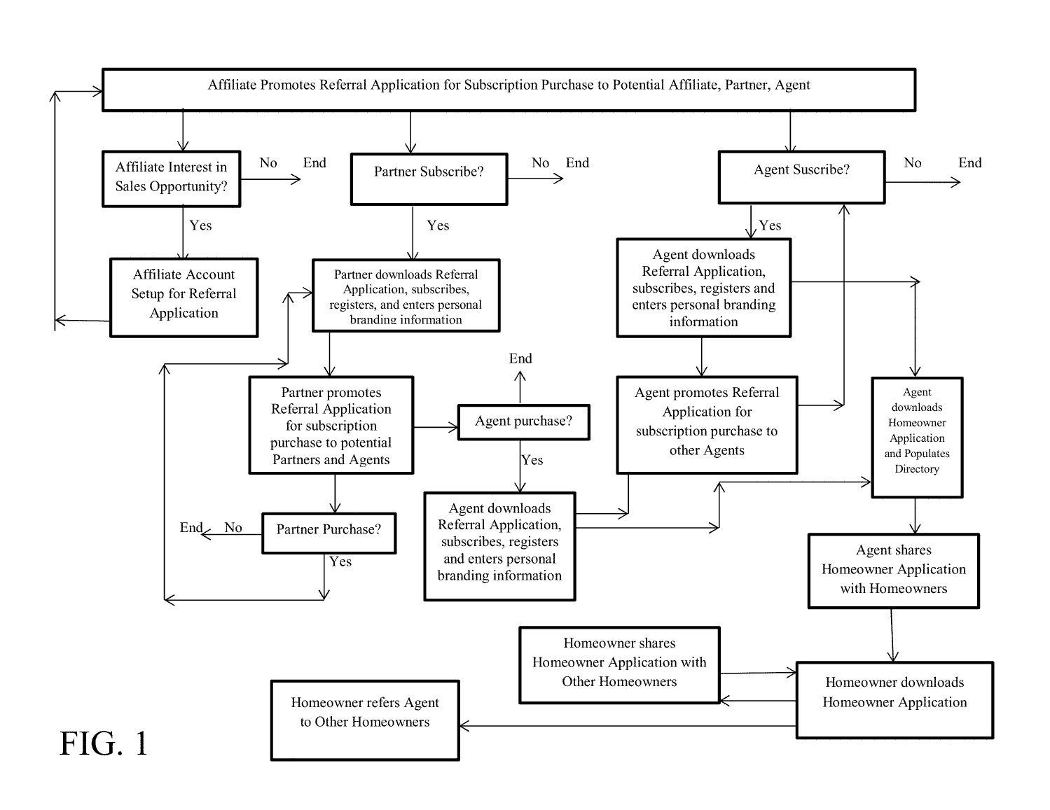

Referring now to FIG. 1, there is shown a flowchart that depicts the proliferation of the present method and system using mobile or computer based applications hereinafter referred to as the invention. The present invention revolves around the use of two mobile or computer based applications. The first application is a referral application and the second application is a homeowner application. For purposes of this application, the term “referral application” can be used interchangeably with the term “first application” and the term homeowner application can be used interchangeably with the term “homeowner application”.

The referral application 20 is focused on the relationship between real estate agents and their respective vendors such as loan officers or title insurance agents hereinafter referred to as “partners”. The referral application 20 allows for the partners to share the referral application 20 with other partners or other agents via a text message or email. The referral application 20 has a dashboard that allows the partners to upload their personal information and picture, contact info and branding information such as logos and trademarks such that it will be prominently displayed on a dashboard of the agent's referral application 20.

The homeowner application 22 is focused on the relationship between the real estate agent and homeowners or potential homeowners. Both the referral application 20 and the homeowner application 22 have dashboards. The homeowner application 22 is linked to the referral application 20 such that the referral application 20 allows the real estate agent to share the homeowner application 22 with homeowners via text message on a mobile device while in the referral application 20. The homeowner application 22 is accessed by an agent through their referral application 20 dashboard.

The homeowner application 22 provides the homeowner with a directory having pre-loaded contacts of vendors of home maintenance and repair contractor services as well as the option to create their own directory listings to be saved. The agent is the party responsible for loading or populating the directory contacts into the homeowner application 22. The agent's directory contacts will then be viewable only by those homeowners who are referred or shared the homeowner application 22 connected to that particular agent. The homeowner application 22 also provides a reminder utility to the homeowner by prompting a homeowner to take a survey or quiz regarding home attributes unique to that homeowner's home and then outputting a customized reminder scheme to their mobile device or computer that alerts a homeowner to certain home maintenance and home repair items that come due every month. The reminder utility also allows a user to enter custom reminders whether they are home related or otherwise. The homeowner application 22 can be shared between agent to homeowner and also between homeowner to homeowner. The homeowner application 22 has customizable agent sponsored advertisements that show up on the homeowner application 22 dashboard.

The referral application 20 provides value to the partner in a number of different ways. One way the referral application 20 provides value to the partner is that every agent who subscribes to the referral application 20 will see the referring partner and their information listed on the dashboard of the referral application 20 which will cause the agent to see the partners name, picture, contact and branding information pertinent to the partner every time the agent uses the referral application 20. Another way the referral application 20 adds value to the partner is by generating and sending email alerts to the agent when either one of two different trigger events occur. The first trigger event is when a homeowner refers their real estate agent to another potential homeowner via the homeowner application 22. This trigger event will prompt an email or text message to be generated and automatically sent via the referral application 20 to the agent alerting them to the fact that they were referred by one of their homeowners who uses the second application to another homeowner and will include information about the new homeowner. The second trigger event occurs when a new homeowner signs up on the homeowner application 22. This trigger event will prompt an email or text message to be generated and automatically sent via the referral application 20 to the agent alerting them to the fact that a new homeowner has signed up and downloaded the homeowner application 22. These email alerts have in their body the branding information of the partners such that the agent consistently sees the partner's picture, contact information and branding information a number of times each month. These email alerts provide advertising benefit for the partners and they also inform the agent of potential new customers by providing the contact information of the referring homeowner or of the new user or potential new user. The referral application 20 provides further benefit and value to the partner because the referral application 20 provides the agent with the homeowner application 22 to proliferate to homeowners such that it allows for the agent to increase the number of homeowners as potential future clients which also could be future clients of the partner when those homeowners need a mortgage or loan for a home purchase, refinance or other financial related service or product.

The referral application 20 in combination with the homeowner application 22 provides value to the agent by having the agent's branding information on the dashboard of the homeowner application 22 so that the homeowner always sees the agent when they use the homeowner application 22 either when they access the directory of contractors or the reminder utility. In addition, the maintenance reminder emails and/or text messages generated by the homeowner application 22 has the agent's branding information on the email and/or text message every time they are sent to the homeowner. Another benefit to the agent is that when a homeowner refers the homeowner application 22 to another homeowner the referring homeowner will receive an email and/or text message from the agent with the agent branding information thanking the referring homeowner. A further benefit of the homeowner application 22 is it allows an agent's homeowners to easily proliferate the homeowner application 22 to other homeowners thereby increasing that agent's pool of potential future clients. When a homeowner shares the second application with another homeowner there is a message generated via email by the referral application 20 to the agent indicating that the homeowner application 22 had been shared with another homeowner and including the name of the referring homeowner, the name of the recipient homeowner of the second application, and the branding information of the vendor partner.

The homeowner application 22 provides the homeowner with a number of benefits. First, the homeowner application 22 provides the homeowner with a home maintenance reminder utility which provides automated email and/or text message reminders to the homeowner based on the homeowner input of a home maintenance survey and any additional custom reminders the homeowner may enter into the homeowner application 22. Second, the homeowner application 22 provides the homeowner with a directory utility of recommended contractors and home maintenance vendors that are pre-loaded by the agent and also allows for a homeowner to add their own custom contacts to their homeowner application 22 directory. Third, the homeowner application 22 provides an extremely simple way for homeowners to refer their agent through the touch of a button without needing to look up agent contact information. Fourth, the homeowner application 22 provides the homeowner a very simple way to share the application without charge to friends or acquaintances who have need of home maintenance vendor contractor directory or of the home maintenance reminder utility.

FIG. 1 shows that there are four different parties involved in the invention: the affiliate, the partner, the real estate agent and the homeowner. The proliferation of the present invention starts with the affiliate who promotes the referral application 20 to other affiliates, partners and real estate agents. Affiliates are the individuals whose primary responsibility is to sell the present invention to partners and real estate agents. FIG. 1 shows that when a partner purchases a subscription to the referral application 20 they will then set up their account and enter their personal information along with their branding information. A partner has the option to promote the referral application 20 to other partners or agents. It will be in a partner's self-interest to promote the referral application 20 to other partners and real estate agents because this will give the partner more potential contacts and clients from which they can draw future business. The agent likewise will have the ability to share the referral application 20 with other agents. The referral application 20 dashboard for the real estate agent is slightly different than that of the partner in that it includes a link to the homeowner application 22. The agent can access their homeowner application 22 through the referral application 20 to set up their homeowner application 22 dashboard. The agent can then share the homeowner application 22 with homeowners through the homeowner application 22 dashboard such that the homeowner can download the homeowner application 22 to their mobile device or other computing device. The homeowner can directly share the homeowner application 22 with other homeowners via the homeowner application 22.

The branding of the referral application 20 dashboard varies by user. The partner's referral application 20 dashboard always has the corporate branding of the company that owns, markets, sells and/or licenses the subscription to the referral application 20 along with the partners information. An agent's referral application 20 dashboard will have the branding of the first partner of whom the referral of the referral application 20 can be traced back to. For example, if Partner A gives the referral application 20 to Agent A, then Agent A will have displayed Partner A's branding info on their referral application 20 dashboard. If Agent A gives the referral application 20 to Agent B, then Agent B's referral application 20 dashboard will also display the branding of Partner A. If Partner A gives the referral application 20 to Partner B, Partner B's referral application 20 will have the corporate branding of the referral application 20 company and Partner B's personal information and branding. If Partner B gives the referral application 20 to Agent C, then Agent C's referral application 20 dashboard will display the branding of Partner B.

The branding of the homeowner application 22 will always display the branding of an agent on a homeowner's homeowner application 22. The agent that gave the homeowner application 22 to the homeowner will have their personal information, picture and/or branding displayed on the homeowner application 22 dashboard of the homeowner. The homeowner application 22 can be given from homeowner to homeowner via the application. The agent branding of the homeowner application 22 will always be that of the first agent to whom it can be traced back when there is homeowner to homeowner proliferation of the homeowner application 22. For example, if Agent A gives the homeowner application 22 to Homeowner A then the branding information of Agent A will be displayed upon Homeowner A+s homeowner application 22 dashboard. If Homeowner A gives the homeowner application 22 to Homeowner B then Agent A+s branding information will be displayed upon Homeowner B+s homeowner application 22 dashboard. If Homeowner B gives the homeowner application 22 to Homeowner C then it is still Agent A+s branding information to be displayed upon Homeowner C+s homeowner application 22 dashboard.

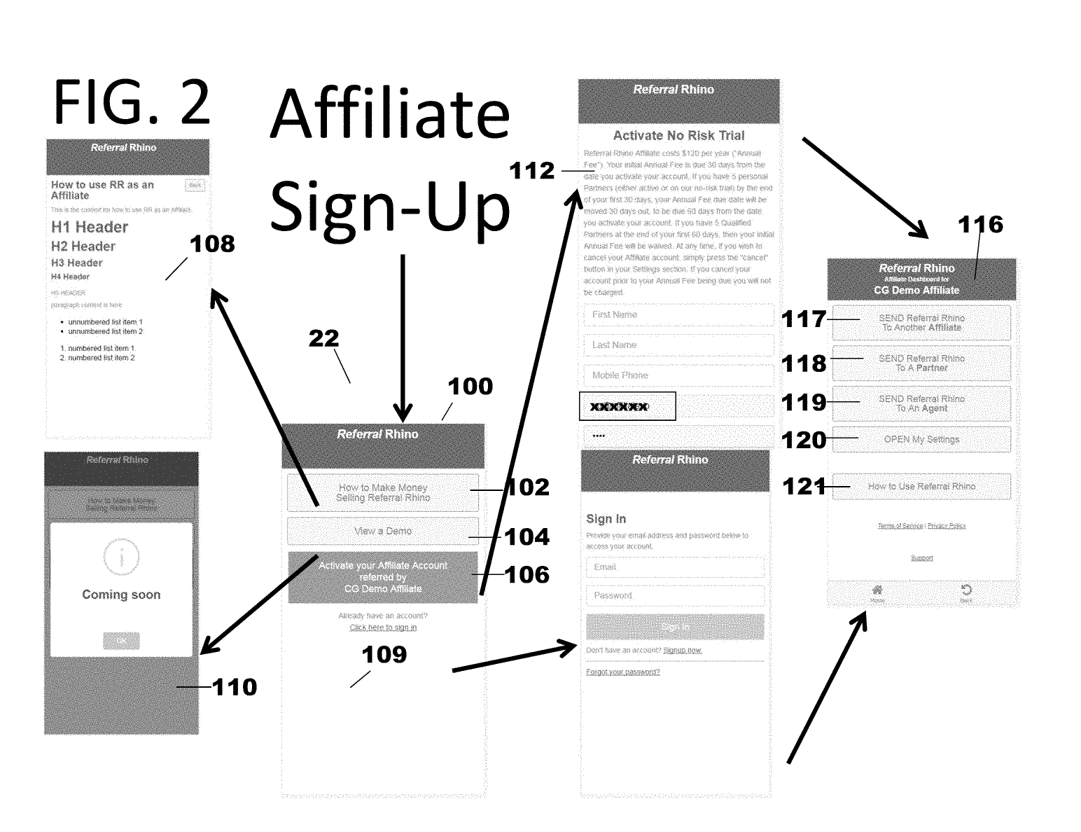

Referring now to FIG. 2, there is shown the affiliate sign up dashboard 100 of the referral application 20 with functionality of various button links. As described above, the referral application 20 is the application that connects the parties. The affiliate is the party that is tasked with introducing the present method and system to potential users such as loan officers and title agents (collectively hereinafter referred to as “partners”) and real estate agents (hereinafter referred to as “agents”). The sign-up dashboard allows the affiliate to learn how to use the application with the how to make money button 102 and view a demo button 104 links. The sign-up dashboard also has an Activate your Affiliate Account button 106 for new affiliates interested in the opportunity to market and sell the referral application 20. There is also a sign in link 109 that once logged into will take the affiliate to the sign in screen 111 where they will enter their email and password which will lead the affiliate to their affiliate dashboard 116 of the referral application 20. Also, shown is the how to use screen 108 of the referral application that contains content that will explain the referral application 20 to the affiliate and how it works. The view a demo button 104 takes an affiliate to the View a Demo screen 110 provides video content to the affiliate to understand how the referral application 20. The activate your affiliate Account button 106 takes an affiliate to the activation screen 112 whereby the affiliate can enter their name, mobile telephone number, email and create a password which once completed will take the affiliate to the affiliate dashboard 116. The affiliate dashboard 116 has a send to affiliate button 117, a send to partner button 118, a send to agent button 119, an open my settings button 120 and a How to Use button 121. Buttons 117, 118, and 119 allow the affiliate to send the referral application to other affiliates, partners and agents.

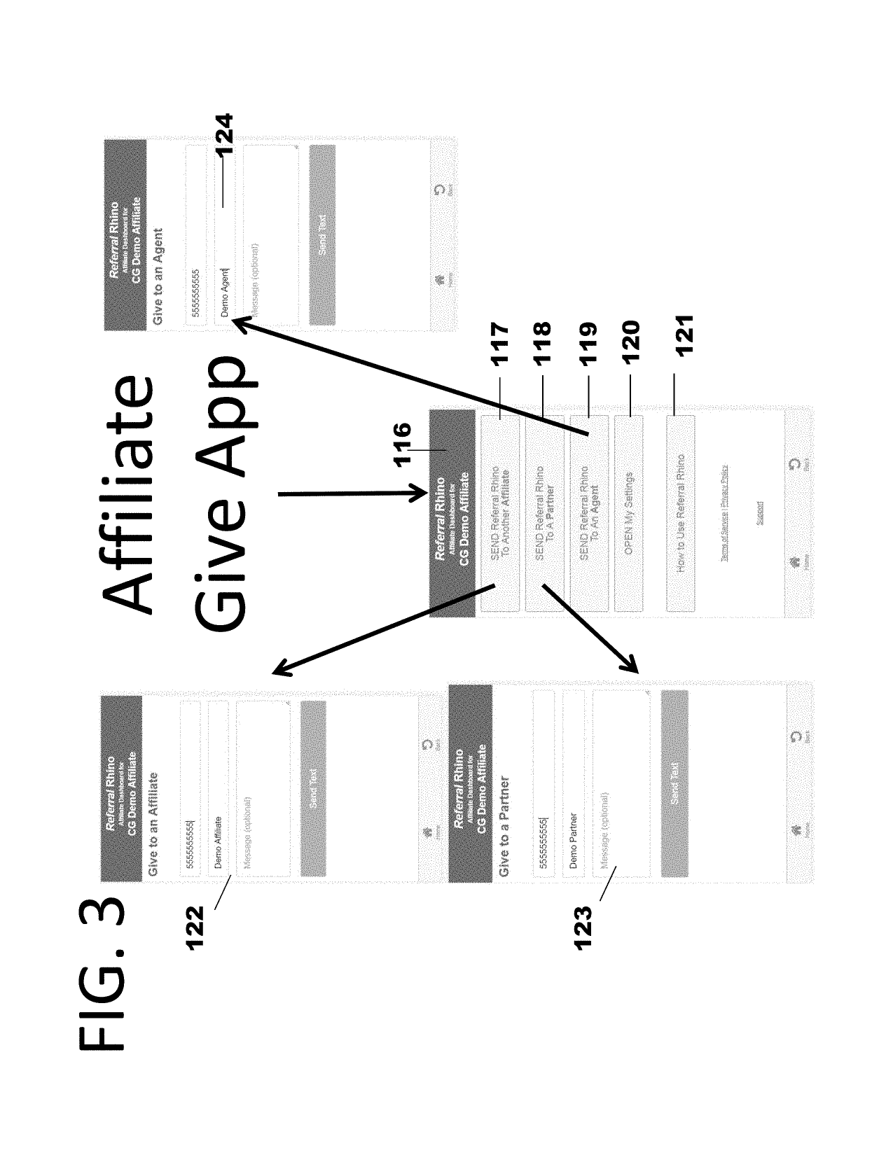

Referring now to FIG. 3, there is shown the affiliate dashboard 116 having button links 117, 118, and 119 to send the referral app via text message to either other affiliates, partners or agents. When an affiliate sends the referral application 20 to either an affiliate, partner or agent, they are taken to a new screen 122, 123 or 124 where the affiliate can enter the mobile device number of the intended person, their name, an optional message and then press the send text button link. The text messages are sent through an SMS texting service via the internet whereby web based servers process the text command, log the data in a cloud database and request and communicate with the texting service the data to be sent and a text message is sent to the intended recipient. A log is maintained by the referral application 20 which records which entities the affiliate has shared the referral application 20 via text message with, and of whom those who the referral application 20 was shared with the number of entities to download and subscribe to the referral application 20.

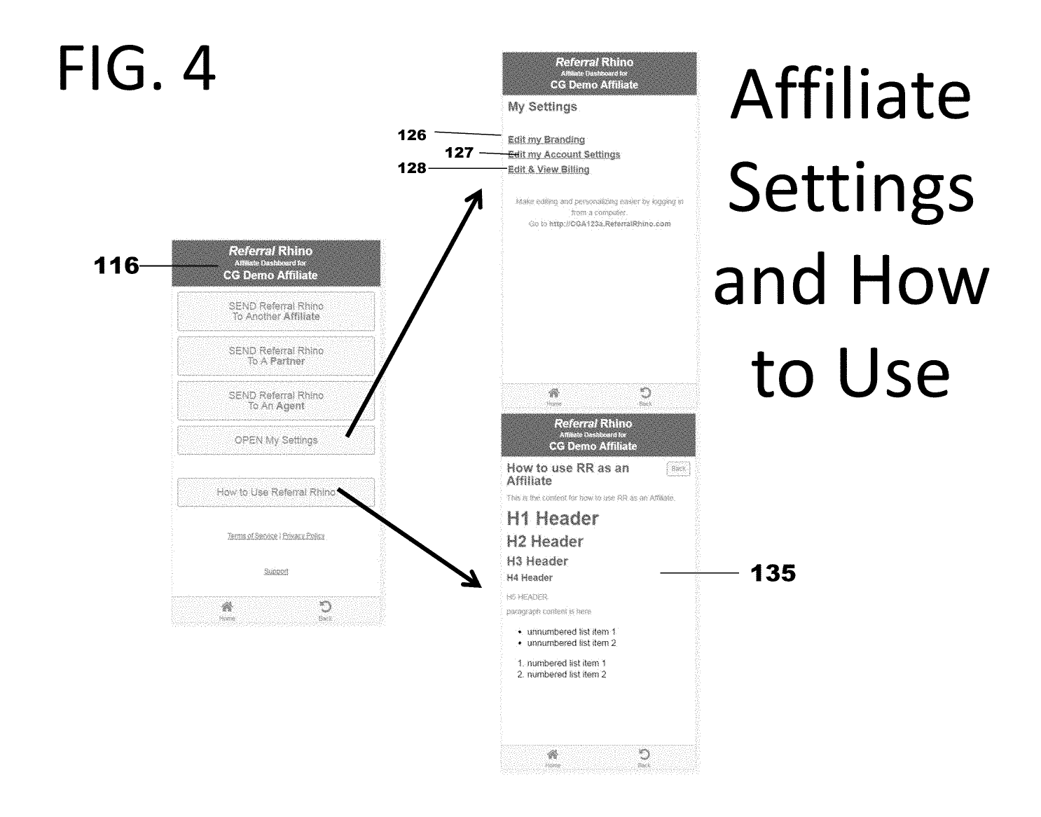

Referring now to FIG. 4, there is shown the corresponding screens to the open my Settings button 120 and the how to use button 121 links displayed on the Affiliate dashboard and the content associated with those button links. The open my settings button 120 takes a user to the my settings screen 125 where the affiliate can access a edit my branding link 126, edit my account settings link 127 and edit and view billing link 128. The how to use button 121 takes an affiliate to the how to use screen 135 where content is displayed explaining to an affiliate how to use the referral application 20.

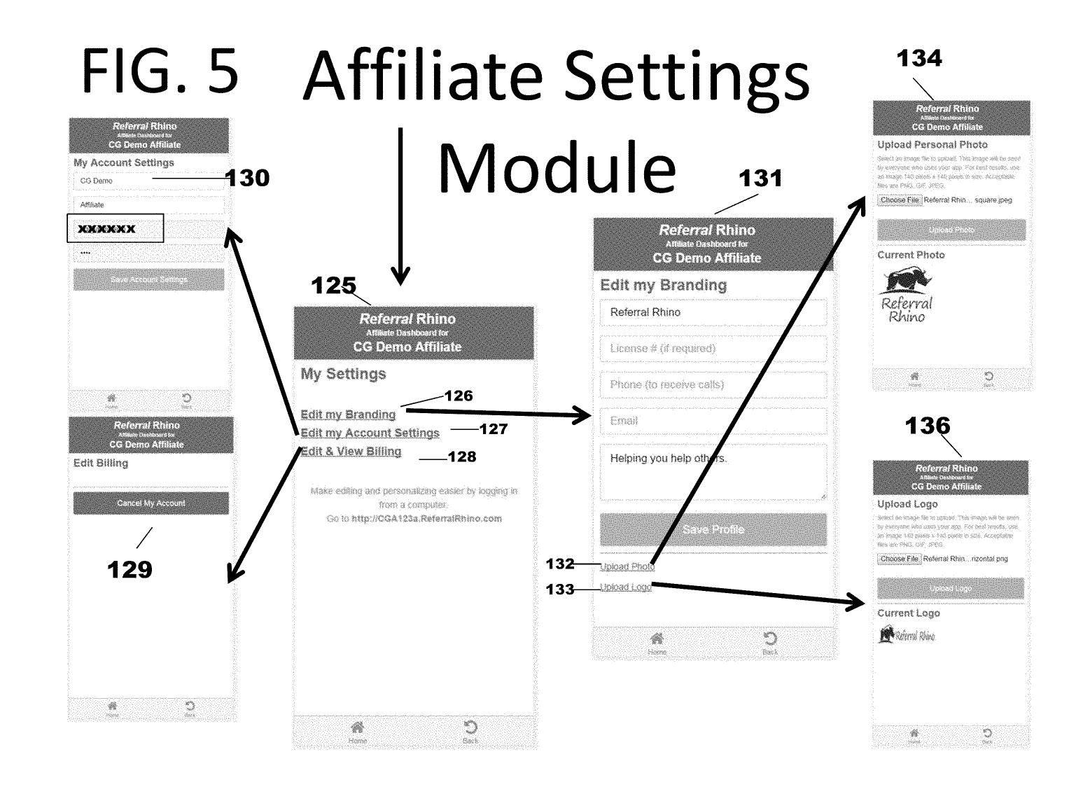

Referring now to FIG. 5, there is shown the branding link 126, account settings link 127 and billing link and their associated screens 129, 130 and 131 that allow the affiliate user to change or customize the settings. The branding screen 131 allows the affiliate to enter personal contact info such as license number, phone number, email and slogan or messaging that will be shown on the affiliate dashboard 116 of the referral application 20. In addition, a user can upload a desired personal photo and logo which uploaded to the cloud based database via an upload photo link 132 and logo link 133 that takes the affiliate to the upload photo screen 134 and upload logo screen 136 whereby an affiliate can choose a file to upload. Affiliate branding will only be shown on the agent's referral application 20 dashboard to whom they are directly connected. Most affiliates sign up partners for subscription to the referral application 20, but they may also directly sign up agents.

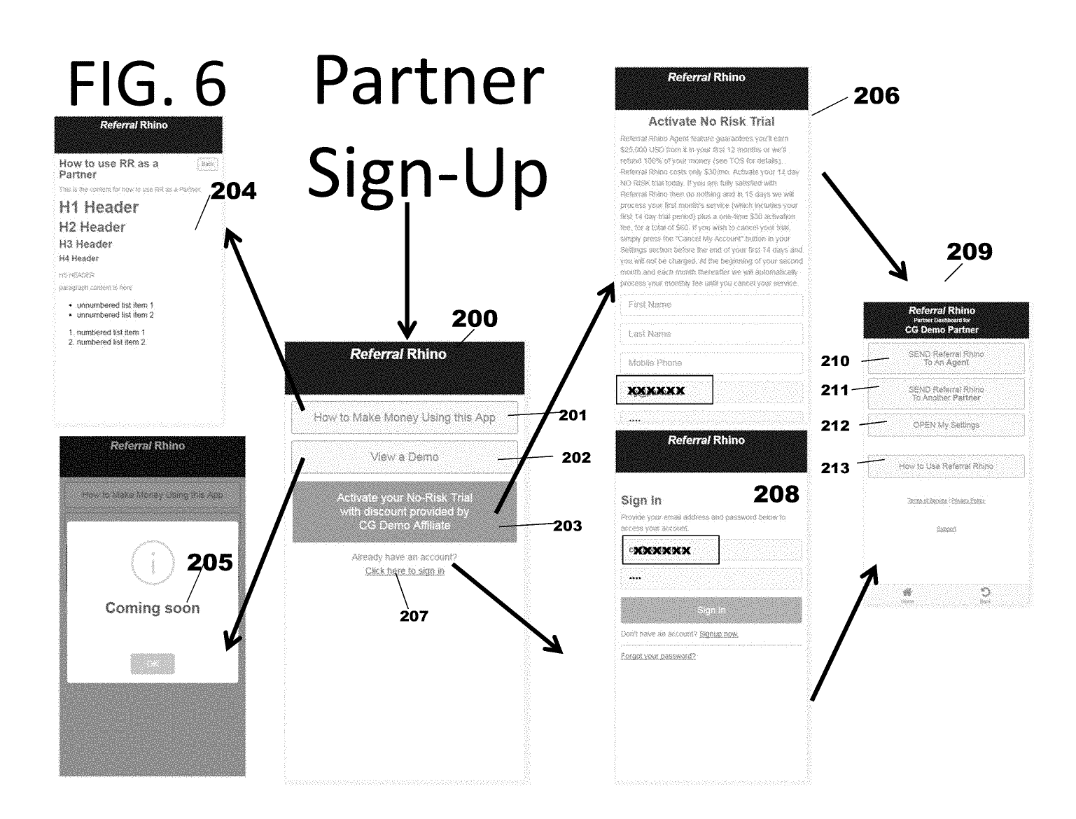

Referring now to FIG. 6, there is shown the partner sign up dashboard 200 with button links how to make money using this app button 201, view a demo button 202, activate trial button 203 and a “sign in” link 207 to take a user to a sign in page 208. There are also shown the view demo screen 205, how to use screen 204, activate trial screen 206 and the partner dashboard 209 of the referral application. The partner dashboard 209 of the referral application has a send to agent button 210, send to partner button 211, open my settings button 212 and a how to use button 213.

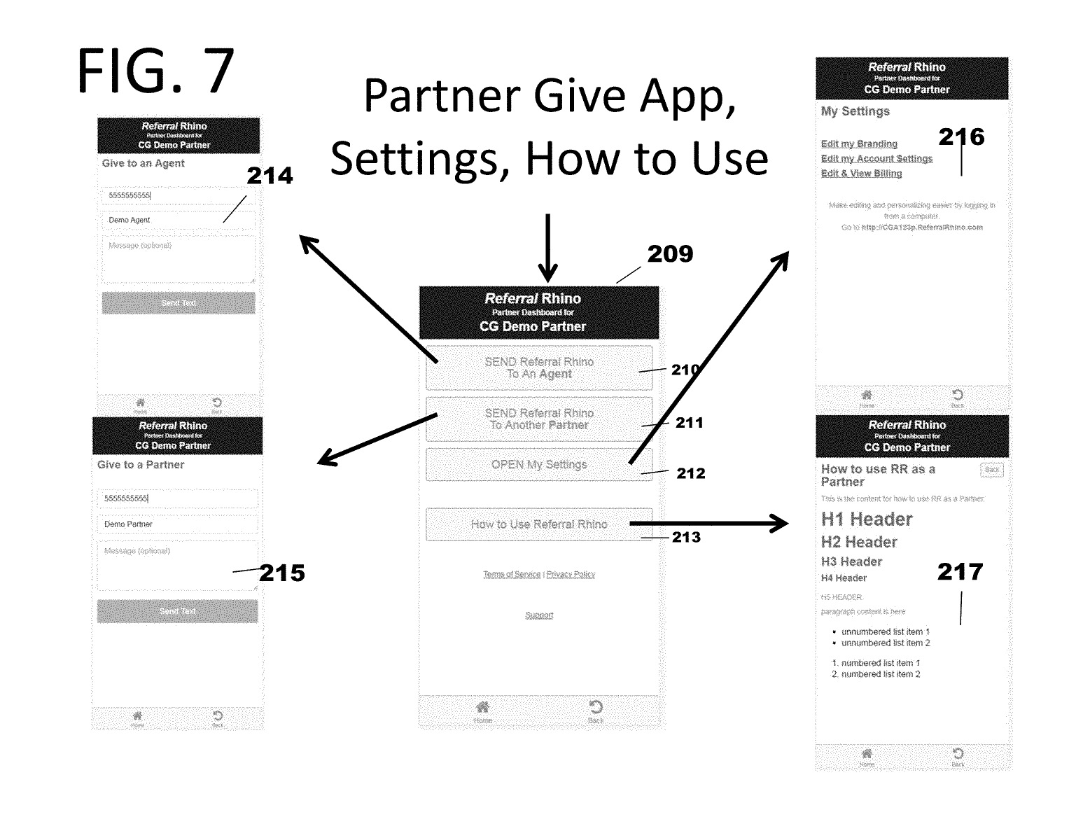

Referring now to FIG. 7 there is shown the partner dashboard 209 that a partner will be able to access once they have agreed to try the risk-free trial and/or subscribed to the referral application 20 service. There is shown button links 210, 211, 212, and 213 that will take a partner to the give to agent screen 214, give to partner screen 215, my settings screen 216 and how to use screen 217, respectively. Screens 214 and 215 allow the partner to enter a mobile telephone number, name and message and to send the referral application 20 to partners or to agents via text message. Additionally, there is a settings button 212 that takes a user to the settings screen 216 where the partner can edit their branding, account settings and billing information. There is also shown a how to use button 213 that takes a user to a screen 217 showing content related to the use of the referral application 20 by the partner.

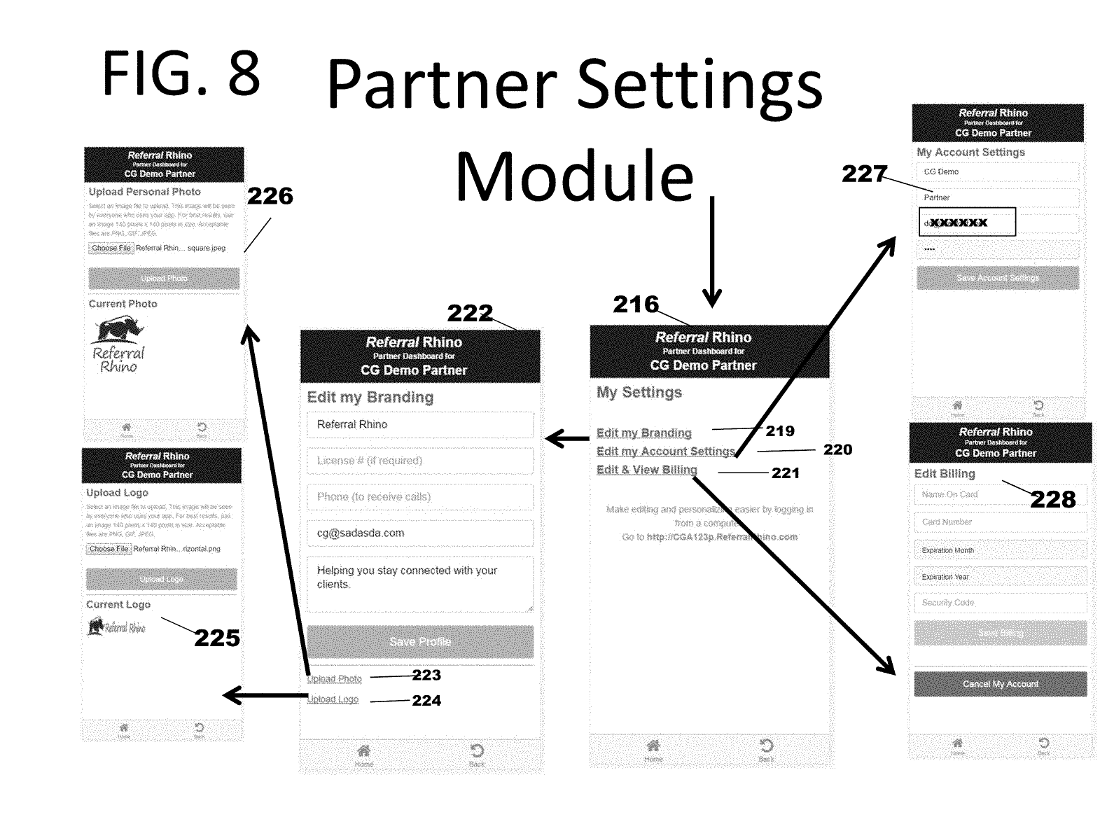

Referring now to FIG. 8, there is shown settings screen 216 having edit my branding link 219, account settings link 220 and billing link 221 that take a partner to the branding screen 222, account settings screen 227 and billing screen 228, respectively. The branding screen 222 allows the partner to enter personal contact info such as license number, phone number, email and slogan or messaging that will be shown on the agent dashboard 209 of the referral application 20. In addition, a partner can upload a desired personal photo and logo which uploaded to the cloud based database via an upload photo link 223 and logo link 224 that takes the partner to the upload photo screen 225 and upload logo screen 226 whereby a partner can choose a file to upload. Partner branding will only be shown on the agent's referral application 20 dashboard to whom they are directly connected. For the partner, this branding information will show up on the agent referral application 20 dashboard and referral application 20 generated emails that alert the agent that a homeowner has referred the agent or shared the homeowner application 22 to another homeowner. Additionally, the partner user can alter their billing information or their personal information and login information via these settings screens 227 and 228.

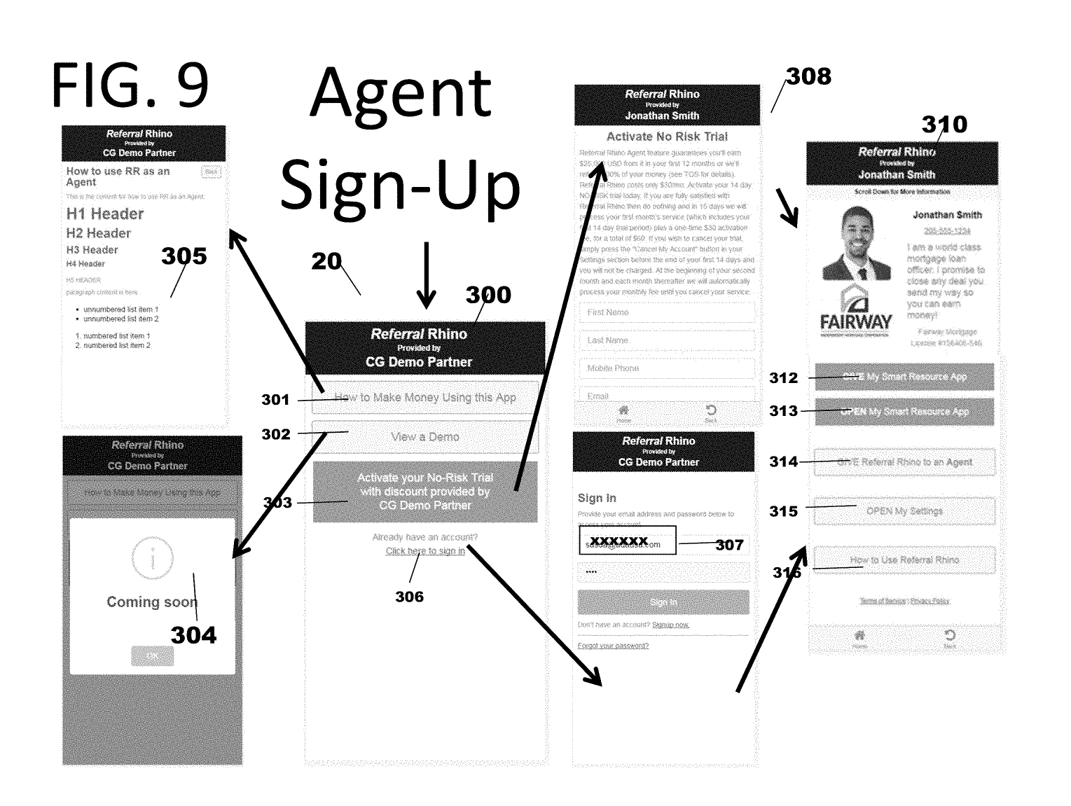

Referring now to FIG. 9, there is shown the agent sign up dashboard 300 that an agent will receive after an affiliate, partner or other agent sends the targeted agent the referral application 20 via text message. The agent sign up dashboard has a how to use button 301, a view a demo button 302 and an activate trial button 303 and a sign in link 306 for existing subscribers takes them to a sign in screen 307. The how to use button 301 takes an agent to a how to use screen 305 and the view a demo button 302 takes the agent to a view a demo screen 304 whereby there is content regarding how to use the referral application 20 and its benefits. The activate trial button 303 will take an agent to the activate trial screen 308 whereby an agent can enter their will enter their personal information and create a user name and password login information. Once the activation is completed by the agent, the agent can open the referral application 20 agent dashboard 310. There is located on the agent dashboard 310 the branding information 311 of the referring partner including a photo, logo, name, telephone number, email and personal message.

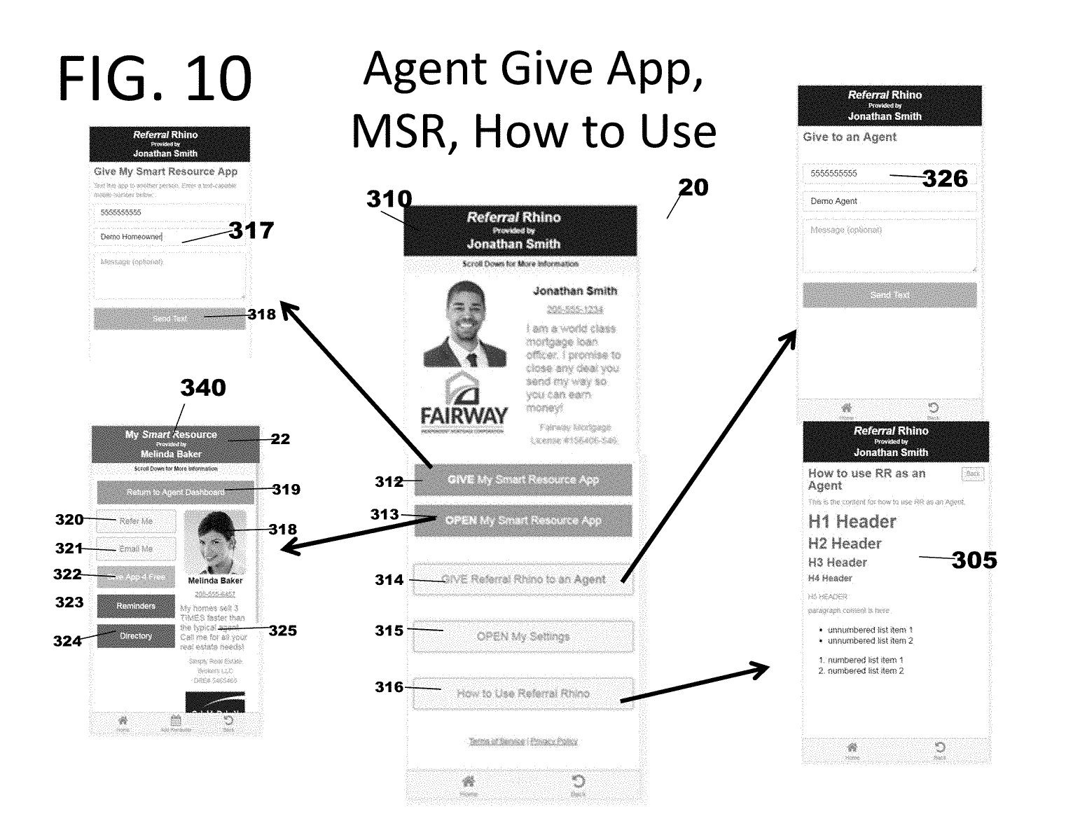

Referring now to FIG. 10, there is shown the agent dashboard 310 of the referral application 20. The agent dashboard 310 contains the branding 311 of the upline sponsor partner that gave the referral application 20 to the agent. In the case where an agent receives the referral application 20 directly from another agent then the partner most closely related on the referral tree will have their branding information 311 displayed on the agent's referral application 20 dashboard. In the scenario where the referral application 20 was given the application by an affiliate, the affiliate branding and corporate branding of the referral application 20 owner or licensee would be displayed on the dashboard. If a partner cancels their subscription, any connected agent will then see corporate branding for the referral application 20. There is also shown on the dashboard button links as follows: give homeowner application 22 button 312, open homeowner application 22 button 313, give referral application to agent button 314, open my settings button 315, and how to use button 316. For purposes of this application, My Smart Resource is the homeowner application 22 which referred to as the second application herein. The give homeowner application button 312 allows the agent to give the homeowner application 22 to a homeowner or potential homeowner by opening a screen whereby the agent can enter the mobile telephone number, or in another embodiment an email, of the intended homeowner with the option to add their name and a personal message and touch the send text button. The open homeowner application button 313 allows the agent to open up their personal homeowner application dashboard 340 return to referral application button 319, a refer me button 320, an email button 321, a give homeowner application button 322, a reminder utility button 323 and a directory utility button 324. The give referral application to agent button 314 link allows an agent to share the referral application 20 with another agent via a screen that opens whereby the mobile phone number or email can be entered along with the name of the agent and a personal message and the “Send Text” button link touched. Also shown is the open my settings button 315. In addition, there is a how to use button 316 that takes the agent to the how to use screen 305 where there is content and instructions to the agent on how to use the both the referral application 20 and the homeowner application 22.

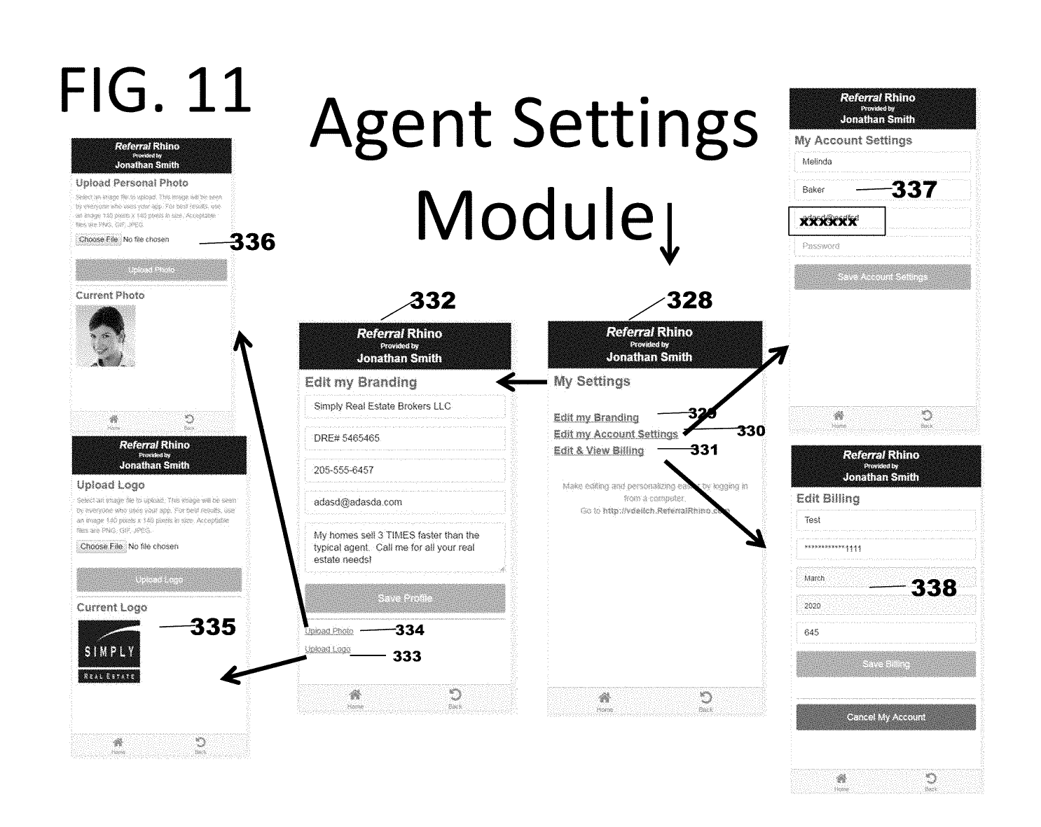

Referring now to FIG. 11, there is shown the my settings screen 328 with a branding link 329, an account settings link 330 and a billing link 331 that an agent can access through the agent dashboard 310 of the referral application 20 that allows an agent user to edit their branding, account settings and billing information. The billing screen 338 and account settings screen 337 allow an agent to change those settings. The branding screen 332 allows an agent to enter their company information, their name, license number, phone number, email and a personal message or slogan to be displayed on homeowner application dashboards. In addition, there is a upload photo link 334 and an upload logo link 333 that an agent can click that will take them to an upload logo screen 335 and a upload personal photo screen 336 whereby they can upload the appropriate files that will display on their referral application 20, homeowner application 22 dashboard and homeowner applications that they share with homeowners. A desired logo, trademark or branding image can also be uploaded into the application. The photo, logo and personal information are uploaded to a cloud based database. The referral application 20 takes the branding information, photo, and logo and imports them from the cloud based database and into the homeowner application 22 dashboard so that the homeowner sees the agent branding whenever they use the homeowner application 22.

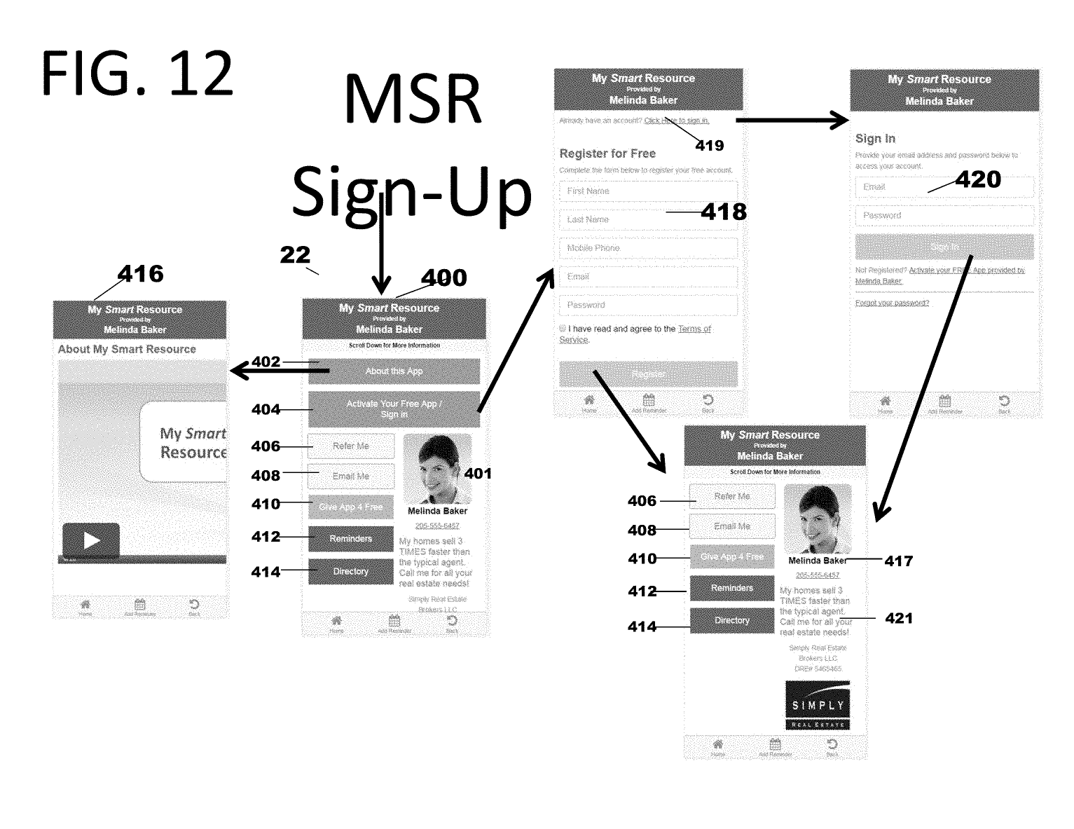

Referring now to FIG. 12 there is shown the homeowner application 22 sign up dashboard 400 whereby a homeowner can choose to register for the application. While a number of button links are shown, only the about the app button 402 and activate your free app/sign in button 404 are functional to a homeowner when they first view the homeowner application 22 sign up dashboard 400 and before they have registered and created an account. Also shown is a button link 406 used to refer the agent to another homeowner, an email me button 408 used to email the agent, a give application button 410 used to give the homeowner application 22 by one homeowner to another homeowner, a reminder utility button 412 used to launch the reminder utility and a directory button 414 used to launch the directory utility. A homeowner will register via the activation screen 418 or will sign via the sign in link 419 which will take them to a sign in screen 420 where they will enter their email and password. Once signed in and/or registered, the homeowner will be taken to their homeowner application dashboard 421 which displays the branding information 417 of the agent. Should the agent cancel their subscription, the homeowner application 22 would be cancelled. In the cancelled version of homeowner application 22, the homeowner can only use the contact functionality to contact the Agent.

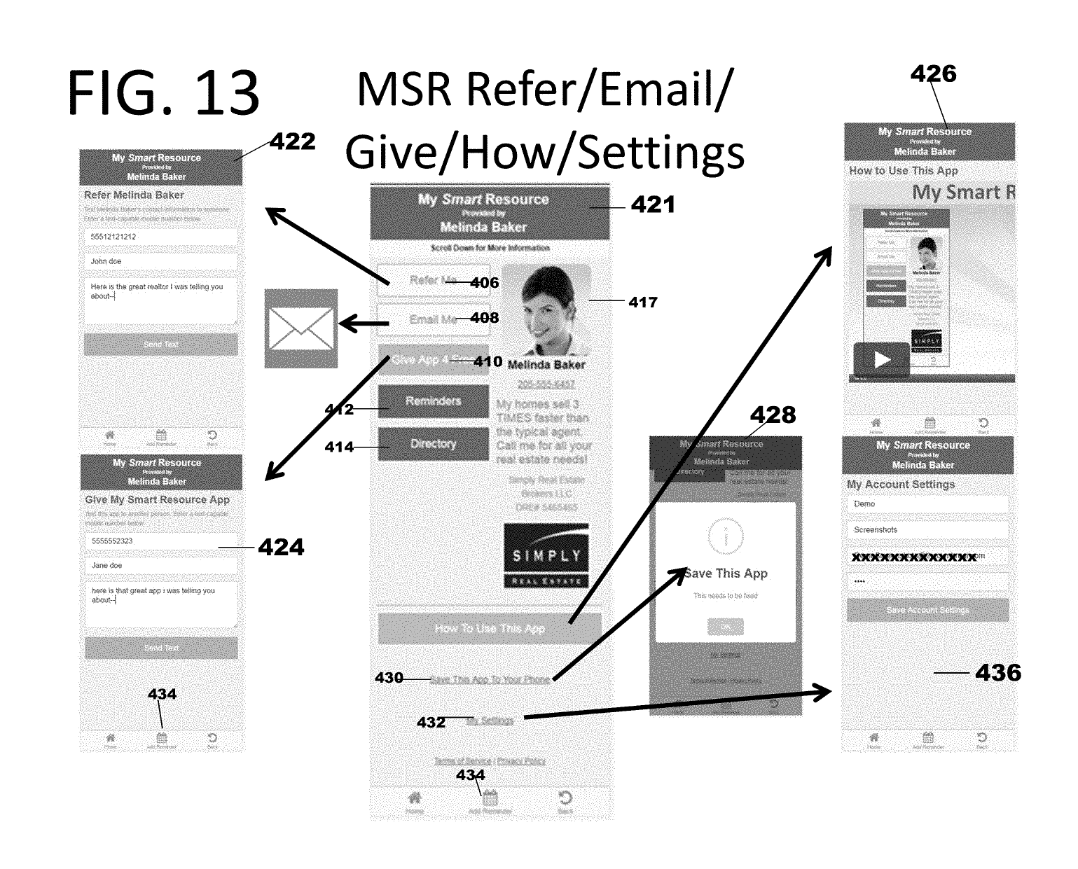

Referring now to FIG. 13 there is shown the homeowner application 22 main dashboard 421 having the branding information 417 of the referring agent along with a number of button links and links. Directly after registering a free account, a homeowner is taken to the main dashboard where they will first need to click or touch the link save this app to your phone 430 whereby they are led the download screen 428 to download the homeowner application 22 to their mobile device or other computing device. The homeowner application 22 allows a homeowner or agent to give the homeowner application 22 through the give homeowner application button 410 that takes them to the give homeowner application screen 424 whereby the homeowner or agent enters the mobile phone number or email of an intended recipient homeowner, their name and a brief message and hits a send text button. The homeowner application 22 allows a homeowner to email the agent through use of the email button 408 whereby they are taken to their mobile device email pre-adressed to the agent's email address whereby they input the email message and send it. The refer me button 406 takes the homeowner to the refer me screen 422 whereby they can enter mobile telephone number or email of another homeowner along with a message and hit the send text button. Every time that a homeowner refers the agent to a homeowner by use of the refer me button 406 or sends the homeowner application 22 to another homeowner via the give homeowner application button 410 there is generated an email by the referral application 20 that is sent to the agent alerting them to the referral or sharing of the homeowner application 22 along with having the branding information of the partner sponsor located on the email such that the partner is able to touch the real estate agent multiple times a year via these email alerts. In addition, there is a how to use app button 415 on the dashboard 421 that takes a user to a how to use screen 426 with various helpful information. There is also located on the main dashboard 421 of the homeowner application 22 a my settings link 432 that allows a homeowner to access the application settings screen 436.

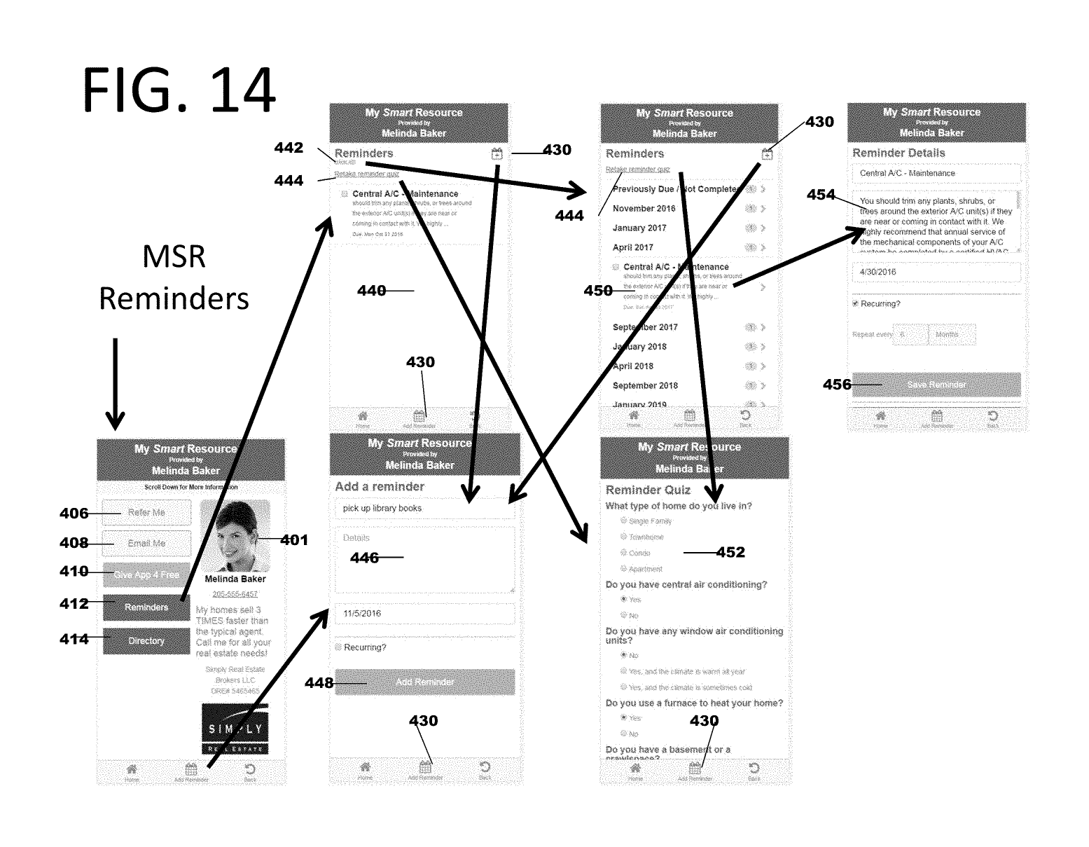

Referring now to FIG. 14, there is shown the main dashboard of the homeowner application 22 having a reminder button 412 that takes a homeowner into the reminders utility screen 440 provided by the application. The reminders screen 440 has a link 442 to view all reminders and also shows reminders currently due. The reminders utility's purpose is to provide an easy automated way that a homeowner can keep up with various home maintenance tasks. The reminders screen 440 has a link 444 that prompts a user to take a reminder survey or quiz on the survey or quiz screen that is purposed to discover as much useful information about that homeowner's home so as to customize automated email reminders to that homeowner based on the existence of particular facts or attributes related to their home. The reminders screen will show current reminder items that have come due and will also show outstanding reminders that remain uncompleted and also shows the branding information of the agent in the body of the message. The reminder survey or quiz can be retaken to update changes that are made in a home or if a homeowner relocates to a different home. There is also shown a reminder list screen 450 segregated into months whereby a month can be clicked on and further individual reminders are displayed such that a homeowner can click on them and is taken to reminder detail screen 454 where they can view the full reminder entry. Additionally,

The main dashboard of the homeowner application 22, as well as the reminders screen 440, allows a homeowner to also add additional reminders by clicking the appropriate button link 430. These additional reminders can be about home maintenance or any other subject. To complete entry of the reminder, a homeowner would enter a reminder title, an optional detailed reminder description and date and time of reminder. Every time a reminder item comes due, an email is sent to, the homeowner reminding the homeowner of that item. In addition, every generated email reminder will contain the branding information of the sponsor agent such as a photo, contact information and promotional language such that it allows the agent to touch the homeowner multiple times throughout a year. Once a reminder is completed, the homeowner can check the box next to the reminder which will then cause the reminder to be indicated as completed. A homeowner will be able to view at least thirty days' worth of completed reminders. Additionally, the reminder utility has functionality to allow a reminder to be tagged as a recurring and a time period for how often the reminder should recur.

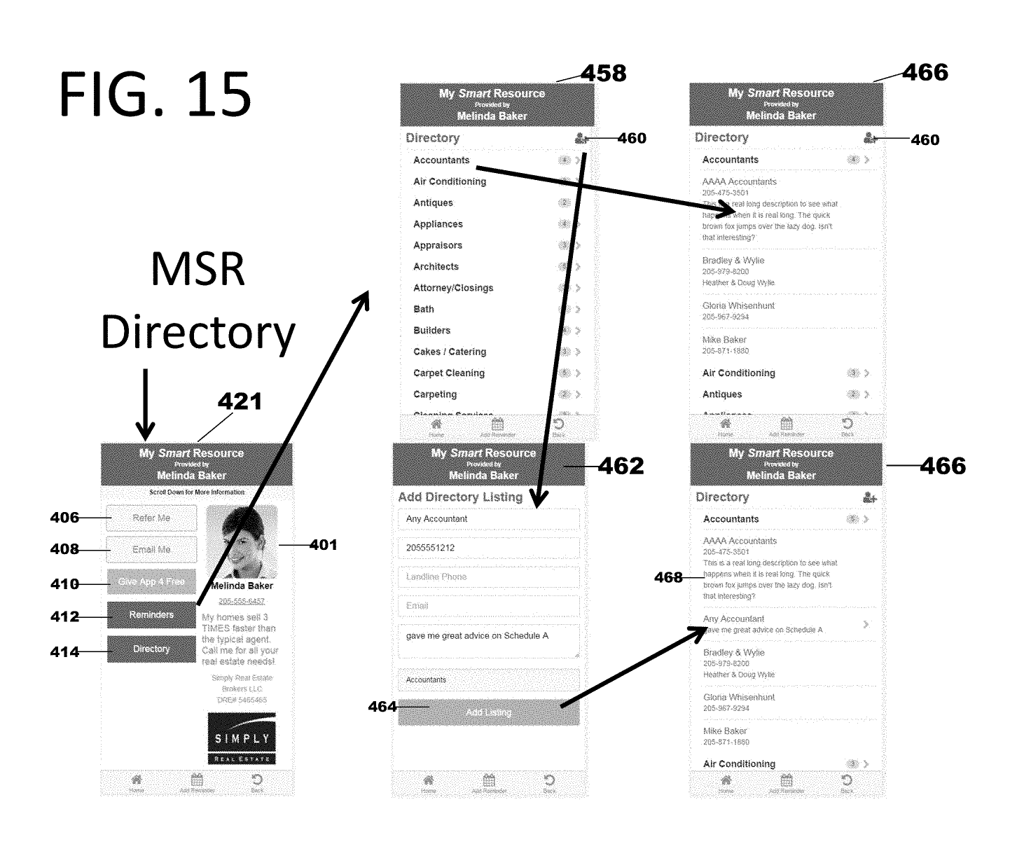

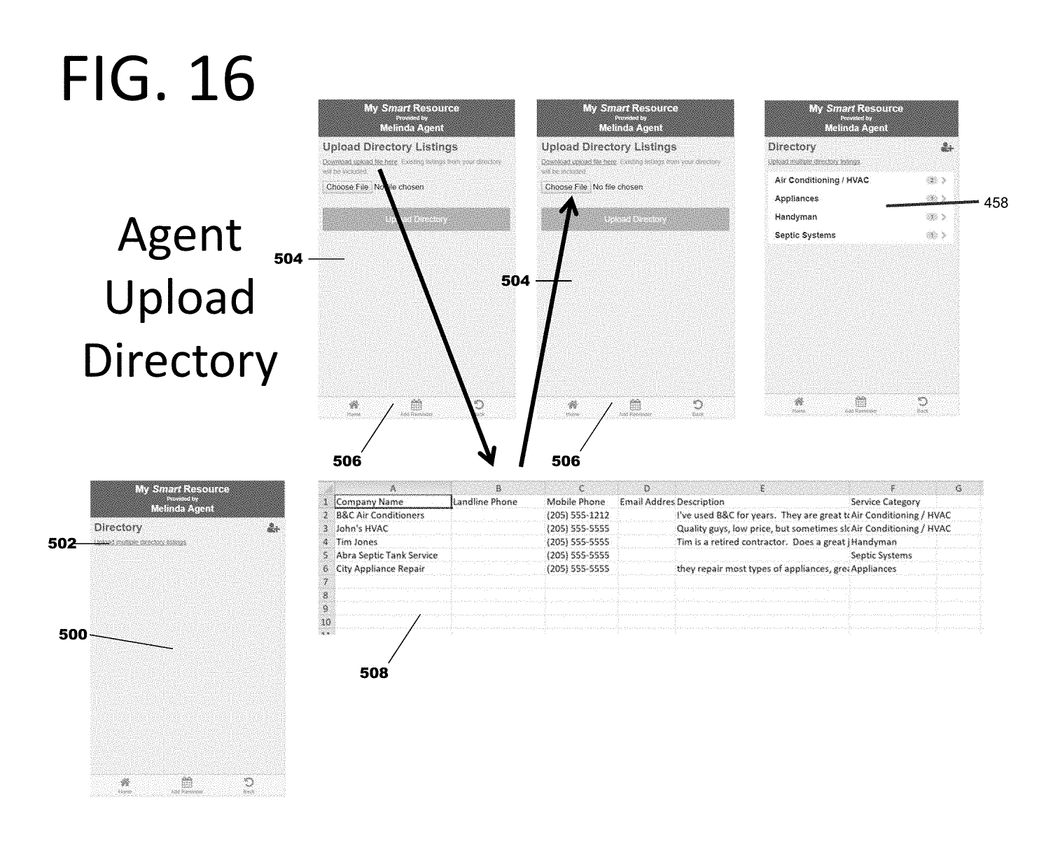

Referring now to FIG. 15, the directory utility button 414 is shown on the homeowner application dashboard 421 and expanded screenshots is shown. The homeowner has access to a pre-loaded directory of contacts of contractors and/or home maintenance vendors that have been pre-loaded by the sponsor agent of their homeowner application 22. The process and utility for an agent loading the contacts into the homeowner application 22 is discussed below in reference to FIG. 16. The directory screen 458 is broken down into a number of categories of contacts by description of services. In addition to the pre-loaded contacts provided by the agent, a user can choose to add their custom contacts to the directory via add directory link 460 provided they conform to the pre-set categories of contacts. Directory screen 466 is an expanded view of directory screen 458. Any contact added by a user can be edited for future changes, but preloaded contacts cannot be edited. As a catch-all, there is a miscellaneous category that can be used by the homeowner to enter any type of contact information they desire.

Referring now to FIG. 16, there is shown the directory utility page screen 500 that is displayed on the agent's homeowner application 22. This screen is unique to the agent homeowner application 22 as it allows them to individually load directory listings one by one or upload multiple directory listings from a spreadsheet file to increase ease of entry by using link 502. Upload directory listing screen 504 allows the agent to choose an appropriate spreadsheet file 508 and to upload the directory 506. The homeowner does not have access to this directory capability nor can they alter any of the agent's directory listings. When an agent downloads their homeowner application 22 off of the referral application 20, the homeowner application 22 for that agent will serve as the home-base or master list for all homeowners that the agent gives their homeowner application 22 to such that the homeowner's application will always contain that agent's branding and directory listings. The agent's directory listings are saved to a cloud based database via remote servers that is accessed by the home application 22.

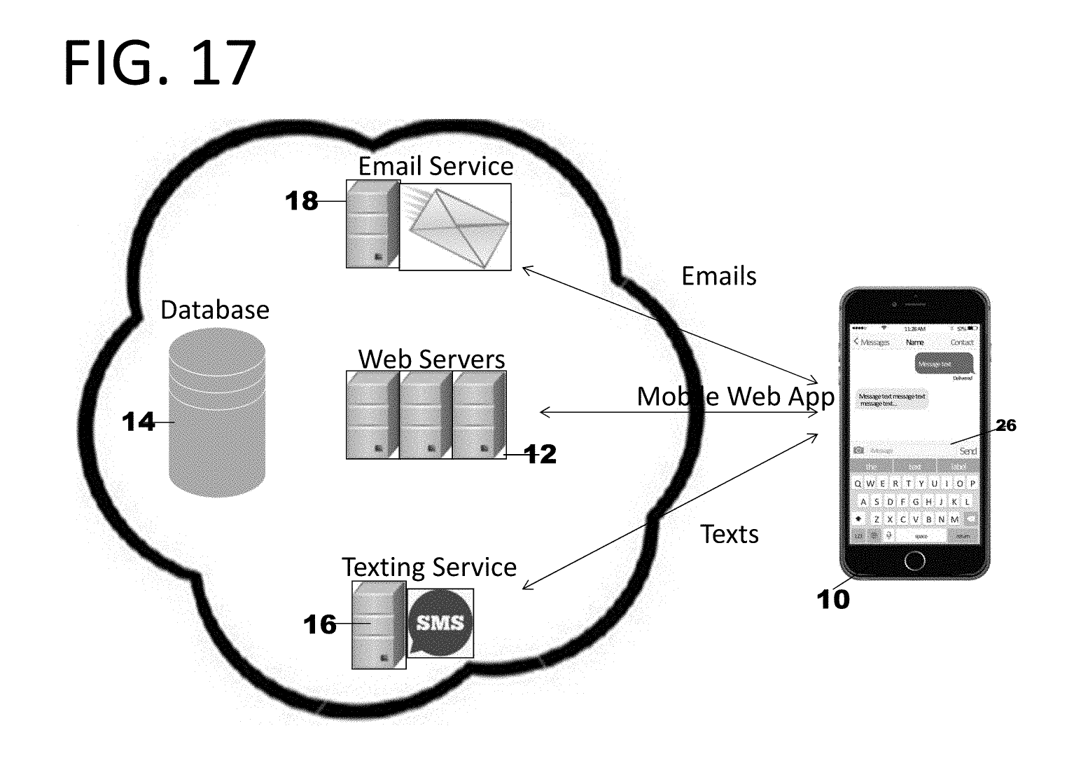

Referring now to FIG. 17, there is shown a mobile device 10 with a graphical user interface 26 shown in communication via the mobile web app with a cloud internet network to a database via a remote server system 12 working in concert with off-site automated text message 16 and email 18 services. The database 14 logs and stores the following: personal user information, photos and logos, directory entries, calendar maintenance reminders, logs, home survey results, sponsor information, user referral tree, referrals, homeowner application 22 shares, agent referrals, and referral application 20 shares among other items. The mobile web referral application 20 and homeowner application 22 utilize off-site email and text message SMS service whereby upon after user-actuated prompts such as homeowner application 22 shares, agent referrals or calendared reminders there is sent various email and text messages in response to those prompts with the appropriate information to be shared along with the branding of the particular party to be displayed.

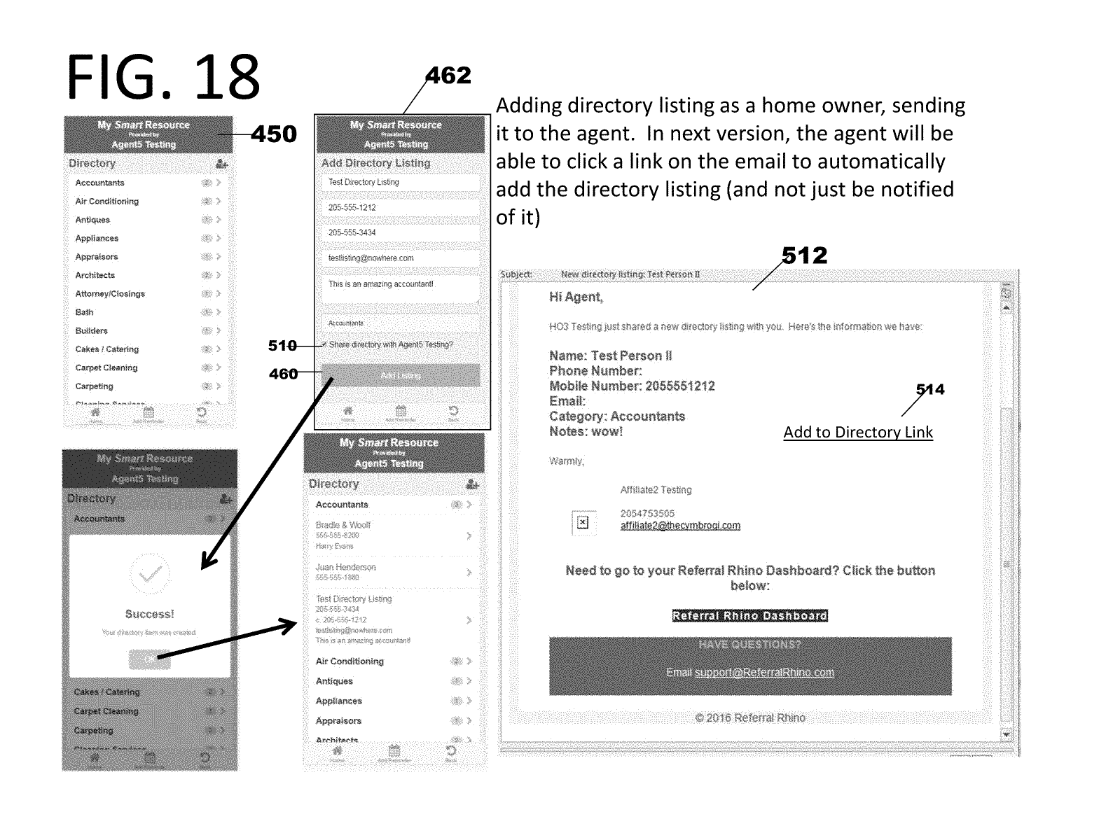

Referring now to FIG. 18, there is disclosed an additional functionality in the homeowner application 22 directory utility 458 whereby a homeowner can elect to share a new directory entry with their sponsoring agent by checking a share directory listing with agent box 510 on the add directory listing screen 462 in the homeowner application 22. Once the homeowner checks the box 510 and clicks the add listing button 460, the directory listing is added to their homeowner application 22 and an email 512 is generated and sent by a remote email service provider to the agent to alert that agent that the homeowner added a new directory listing and provides the agent with the new directory listing. The agent can then review the directory listing, make contact with the directory listing service provider, and then choose whether to populate the agent's directory with the new listing. The new directory listing can be entered manually into the agent's directory by the agent or the generated email will include a link 514 that an agent can press to automatically add the new listing to the agent's directory. As discussed herein, the agent directory and/or master directory as it may also be called, is shared to all homeowner's who received the homeowner application 22 through that particular agent. The ability for a homeowner to share their directory listings allows the agent to mine, screen and then populate their master directory with numerous directory listings that they otherwise would not have had knowledge or access. The increased number of listings in the directory make the homeowner application 22 more valuable to the homeowner. The more valuable the agent directory is, the more likely the homeowner will use it more frequently. Use of the agent directory by the homeowner causes the homeowner to encounter the agent photo and name due to the branding of the agent's info on the homeowner application 22 and by use of the display icon bearing the agent's picture. This repetitive contact between the homeowner and the agent through the homeowner application 22 ensures a higher engagement rate for the agent in new home buy/sell transactions with the agent. In addition, the ability for a homeowner to share directory listing additions with the agent also benefits the partner by way of the partner's branding information being inserted and present on the emails generated to the agent alerting the agent of a newly added directory listing.

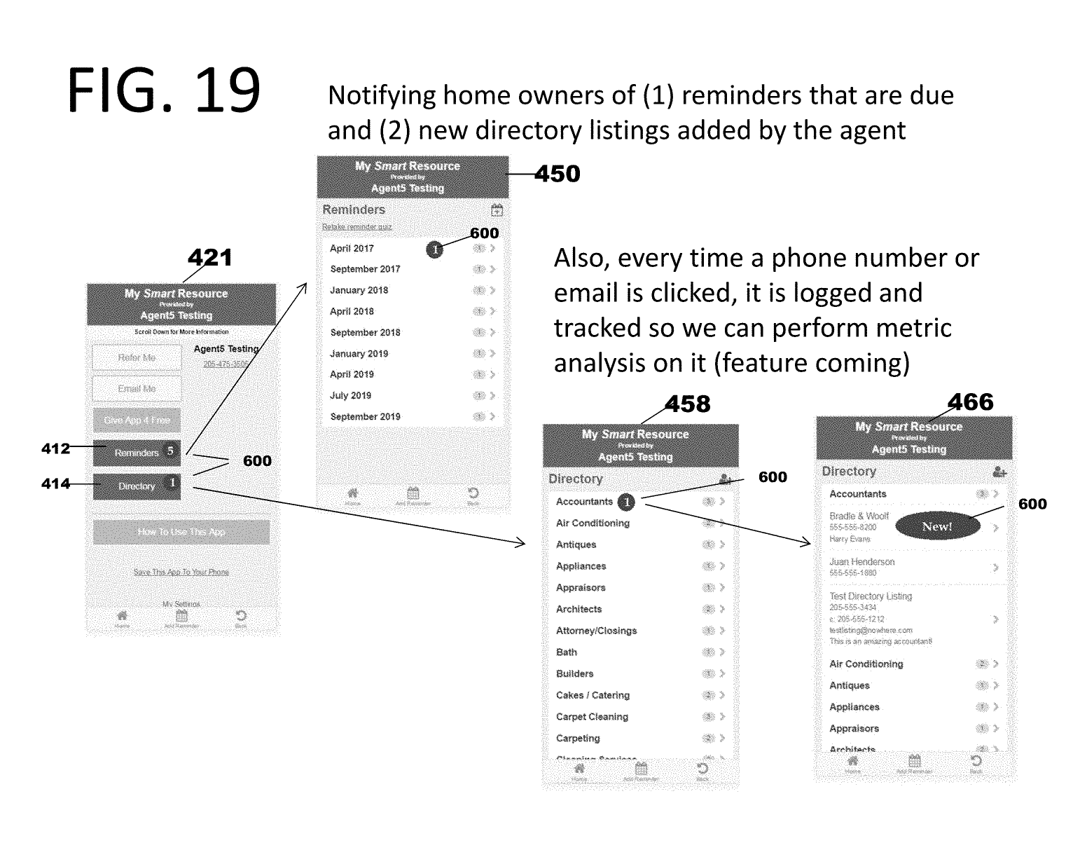

Referring now to FIG. 19, there is shown the homeowner application 22 dashboard 421 with the reminder utility button 412 and directory utility button 414. When reminders or new directory listings have been added to the agent's directory an email message, text message and/or in-application notification alerts 600 will be generated to let the homeowner know of the new directory listings. The in-application notification alerts 600 are generated on the reminders 412 and directory buttons 414. In the present embodiment the in-application notification alerts 600 appear as red circles with a number indicating how many reminders are due or how many new directory listings have been added. Once a user clicks or presses the reminders button 412, the notification alert appears on the month on which the reminder is due in the reminder list screen 450. Upon clicking or pressing the directory button 414, the notification alert appears on the classification of service industries in the directory screen 458 in which the new directory listing was added and then another notification alert 600 appears next to the individual listing located within the service industry category. An additional feature of the homeowner application 22 is the ability of the homeowner application 22 to track and log every time a directory listing phone number or email is clicked by the homeowner for purposes of measuring metric analysis and frequency of use of particular directory listings. This data is stored via the internet in the cloud via remote servers and databases. New directory listing alerts or notifications allow the agent to stay in front of the homeowner on a frequent basis such that it keeps the agent in the forefront of the homeowner's mind while at the same time benefitting

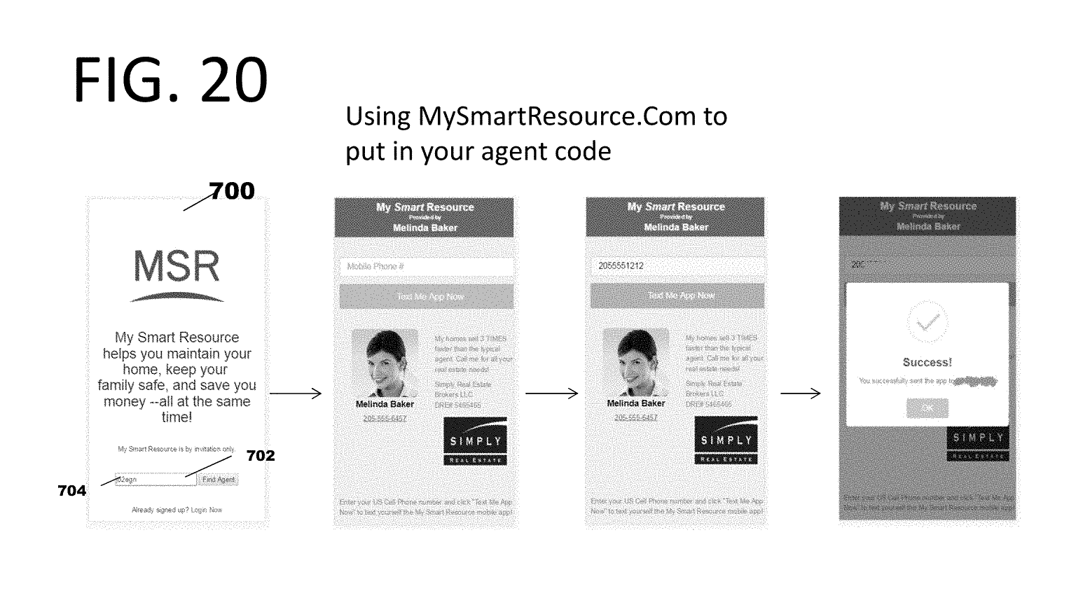

Referring now to FIG. 20, there is disclosed a companion website 700 and an entry field 702 located thereon whereby it asks a homeowner for a code 704 to be entered that in some form has been provided to them by an agent. This allows an agent to send out mass media (emails, post cards, flyers, etc.) containing a unique code 704 to a multitude of people and more quickly have individual homeowners sign up for the homeowner application 22. This approach augments and works alongside of agent to homeowner and homeowner to homeowner proliferation of the homeowner application 22. Once a homeowner enters the agent provided code, they are prompted to enter their cell phone number on the companion website and thereafter the homeowner application 22 invite is texted to their mobile telephone device via the companion website and associated cloud texting service. When the homeowner enters their mobile telephone number for the homeowner application 22 to be sent to their mobile device via text message there is generated a communication (text or email) to the agent. This communication alerts the agent to the fact that a new homeowner has downloaded the homeowner application 22 and also includes branding information of the partner on the same communication such that the partner stays in forefront of the agent's mind.

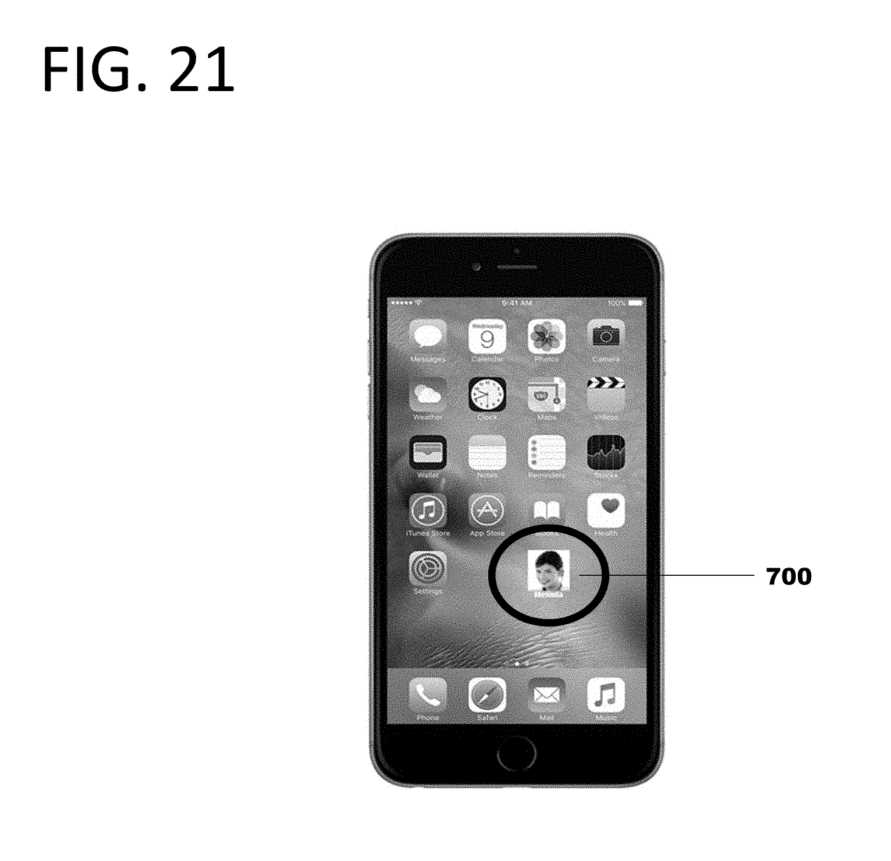

Referring now to FIG. 21, there is shown a mobile device having an icon 602 whereby the icon 602 is the picture and name of the agent that is the sponsoring agent for a homeowner application. Clicking the icon takes the homeowner into the homeowner application 22 dashboard 421. In-application notification alerts are generated on the icon 602 when a new directory listing is added or a reminder item is due.

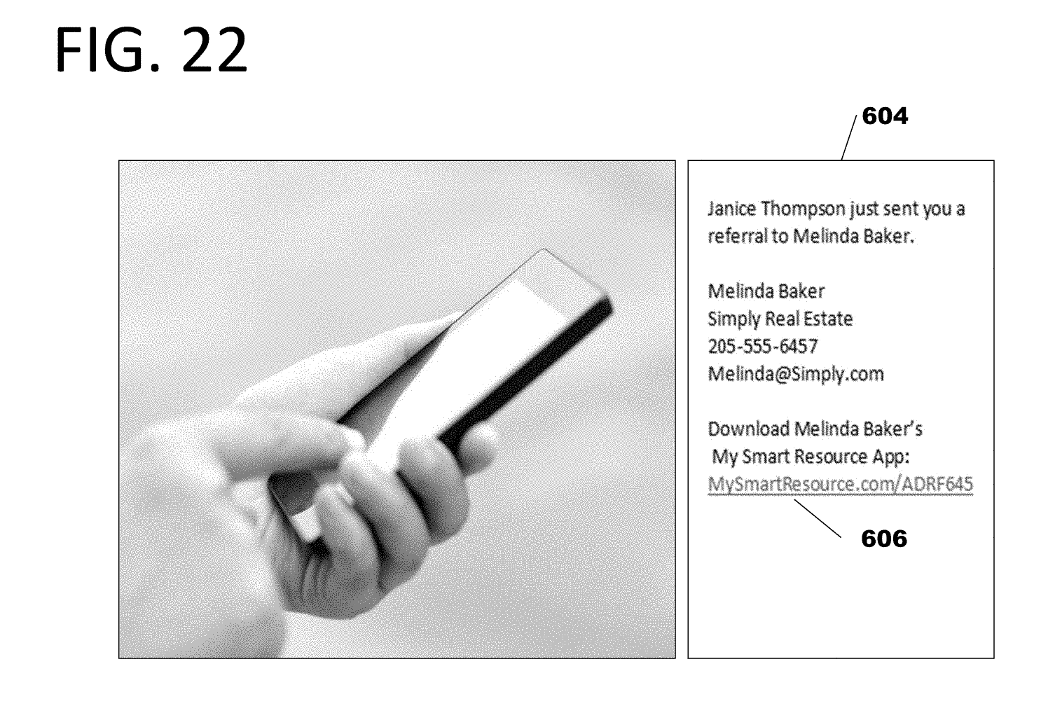

Referring now to FIG. 22, there is shown a text message 604 that is generated and sent by a remote texting service via the cloud when a homeowner refers the homeowner application 22 to another homeowner. The text message provides the homeowner with the agent's contact information as well as a link 606 to download the homeowner application 22.

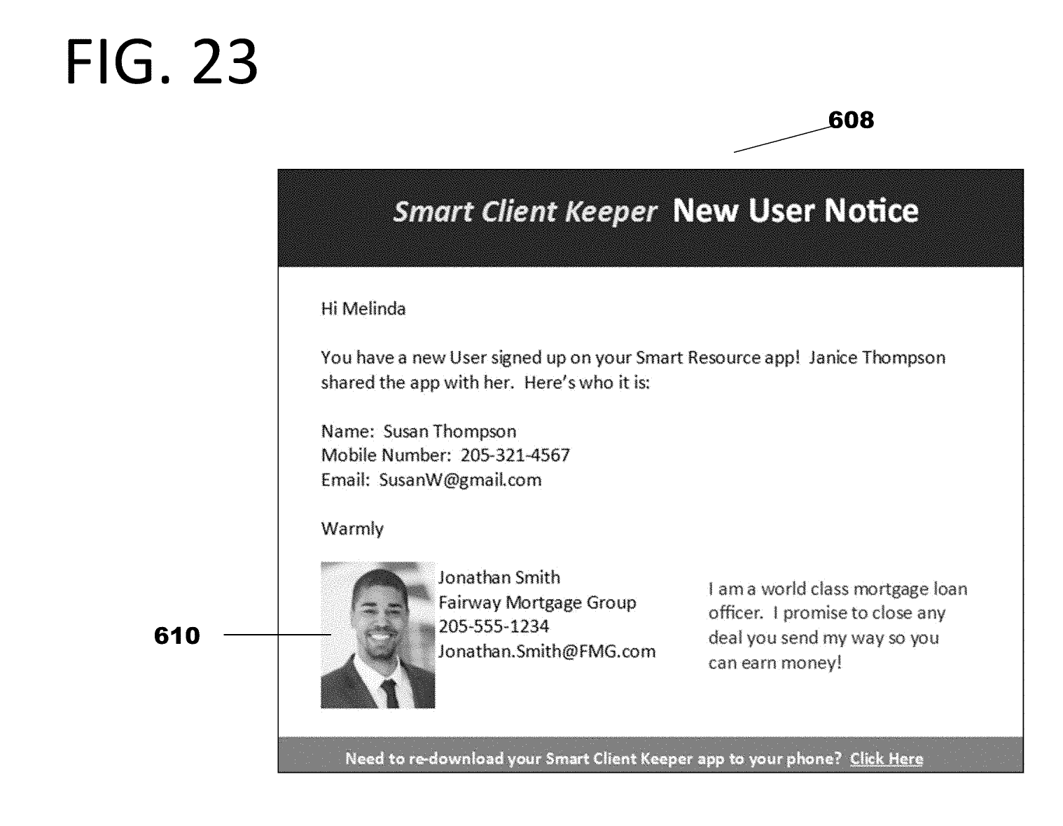

Referring now to FIG. 23, there is shown an email message 608 that is generated and sent by a remote email service via the cloud to an agent by a partner when a new user has downloaded and signed up for the homeowner application 22. Also shown is the partner's branding information 610 in the email message 608.

Referring now to FIG. 23, there is shown an email message 608 that is generated and sent by a remote email service via the cloud to an agent by a partner when a homeowner who has received the homeowner application 22 from an agent refers the agent to another homeowner via the homeowner application. Also shown is the partner's branding information 610 in the email message 608.

Referring now to FIG. 26 there is shown an email message 608 that is generated and sent by a remote email service via the cloud to a homeowner by an agent containing descriptive alerts regarding reminder items that have come due. The email message shows reminder items that are currently due and outstanding reminders that have already been sent to homeowner but are revisited in the email message 610. Also shown is the branding information 612 of the agent.

A homeowner application 22 subscription can be cancelled at any time by a partner or agent. The process takes 30 days to complete. During the 30 days a pop-up reminder will deploy on the partner or agent's dashboard alerting them that they have a certain number of days left before their account is terminated and that they can click a Reactive button on the homeowner application 22 such that their account is reinstated. During this time an email save-the-account campaign is commenced to retain the partner or agent.

In another embodiment, a company can elect to subscribe to the referral application 20 for all of their partners and/or agents. In such case, the icon for the referral application 20 on a user's mobile device or computer screen will be the branding of the company for whom the partner or agents work for. The branding information of the particular partner or agent would be displayed when the referral application 20 is opened. If a partner or agent leaves the company and/or is no longer employed by the company, the partner or agent cannot take the agents or homeowners, respectively, that have signed up for the homeowner application 22. Those agents or homeowners will be tied to the subscription that the company owns on the referral application 20 and will likely be passed to other partners/agents in the company or be given to a new partner/agent. This prevents referrals and relationships that are built by the previous employee from leaving the company and going with the leaving partner or agent.

### Implementation of Methods and Systems Using Software and Hardware and Cloud Computing

The systems and methods described herein may be implemented or performed by software stored on one or more tangible computer-readable media (e.g., one or more optical media discs, volatile memory or storage components (such as DRAM or SRAM), or nonvolatile memory or storage components (such as hard drives)) and executed on one or more computing systems. The computing systems can include one or more central processing units (CPUs) and a memory, such as random access memory (RAM) for temporary storage of information and/or a read only memory (ROM) for permanent storage of information, and a mass storage device, such as a hard drive, diskette, or optical media storage device.

Such software can be executed on a networked computer (e.g., via the Internet, a wide-area network, a local-area network, a client-server network, or other such network). The systems and methods disclosed herein can also be performed using cloud computing, a form of Internet-based computing, whereby shared resources, software and information are provided to computers and other devices on-demand through cloud based servers and databases and executable code. The software embodiments disclosed herein can be described in the general context of computer-executable instructions, such as those included in program modules, which can be executed in a computing environment on a target real or virtual processor.

The computing system may run on a variety of computing devices, such as, for example, a server, a Windows server, a Structure Query Language server, a Unix server, a personal computer, a mainframe computer, a laptop computer, a mobile device (e.g., a smartphone, cellphone, tablet, a personal digital assistant), a kiosk, an audio player, and so forth. As used herein, “mobile devices” and/or “smartphone devices” means any mobile telephone offering advanced capabilities and having PC-like functionality or any mobile phone that runs complete operating system software and provides a standardized interface, display screen, input interface and platform for applications. Examples of current smart phone type devices, operating systems, and manufacturers include, but are not limited to, the APPLE IPHONE™, APPLE IOS™, ANDROID™, WINDOWS MOBILE OS™, BLACKBERRY™, and others.

Furthermore, any of the software embodiments (comprising, for example, computer-executable instructions for causing a computer to perform any of the disclosed methods) can be transmitted, received, or accessed through a suitable communication means. Similarly, any data structure, data file, intermediate result, or final result created or modified using any of the disclosed methods can be transmitted, received, or accessed through a suitable communication means. Such suitable communication means include, for example, the Internet, the World Wide Web, an intranet, wireless distribution networks (3G, 4G, WiFi, satellite, etc.) cable (including fiber optic cable), magnetic communications, electromagnetic communications (including RF, microwave, and infrared communications), electronic communications, or other such communication means now known or unknown. Moreover, any data structure, data file, intermediate result, or final result produced by any of the disclosed methods can be displayed to a user using a suitable display device (e.g., a computer monitor, display, touchscreen display). Such displaying can be performed as part of a computer-implemented method of performing any of the disclosed methods.

The referral application 20 and the homeowner application 22 can either be developed as either native mobile device apps and/or web-based applications using HTML5 and Javascript. A web application is typically coded in a browser-rendered language such as HTML5 combined with JavaScript, and is designed for a lightweight execution in a browser graphical user interface environment. There is a cloud based database whereby executable code talks to the web server and executable code that talks to the mobile device through hypertext transfer protocol (http) and secure hypertext transfer protocol (https). The executable code also talks to service providers for email and texting operations such that when a user via a user interface enters commands on the applications the email and texting operations send the event prompted messages to partners, agents and homeowners. For purposes of this application the term “mobile application” and “web application” can be used interchangeablely.

The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structure available to a person of ordinary skill in the art in any way, but rather to expand the range of equivalent structures in way not previously contemplated. Numerous variations and changes can be made to the foregoing illustrative embodiments without departing from the scope and spirit of the present invention.

What is claimed is:

1. A method for mutually benefitting a plurality of parties in the real estate industry using computing applications, comprising:
providing a first application downloadable and installable onto a mobile device memory or other computing device having a memory, processor, and display, said first application purposed for connection of an affiliate, partner or agent with other, affiliates, partners and agents;
providing a first application dashboard whereby a plurality of actions can be implemented by selecting the desired link corresponding to said actions;
electronically sharing the first application by an affiliate with another affiliate, partner or agent, or electronically sharing the first application by a partner with another partner or agent, or electronically sharing the first application by an agent with another agent;
displaying the branding information of the partner who electronically shared the first application with the agent on the agent's first application dashboard;
providing a second application downloadable and installable onto a mobile device memory or other computing device memory by a homeowner whereby said second application is first electronically shared by an agent with a homeowner via the first application;
providing a second application dashboard whereby a plurality of actions can be implemented by selecting the desired link corresponding to said actions;
electronically sharing the second application by an agent with a homeowner or by a homeowner with other homeowners;
displaying the branding information of the agent who electronically shared the second application with the homeowner on the homeowner's second application dashboard
providing a directory utility within the second application;
providing a reminder utility within the second application;
displaying the photo and name of a referring partner as an icon for the first application on an agent's mobile device display; and
displaying the photo and name of a referring agent as an icon for the second application on a homeowner's mobile device display.

2. The method of claim 1 further comprising the step of displaying the branding information of the partner on all agent's first application dashboards whose receipt of the first application can be traced back through other agent's receipt of the first application to that partner.

3. The method of claim 1 further comprising the step of displaying the branding information of the agent on all homeowner's second application dashboards whose receipt of the second application can be traced through other homeowner's receipt of the second application back to that agent.

4. The method of claim 1 whereby the reminder utility prompts a homeowner to take a home survey whereby the answers are logged into an offsite database via remote servers and implementing and outputting a customized reminder alert schedule whereby alerts sent via text message or email are automatically sent to the homeowner as reminder items become due.

5. The method of claim 1 whereby an agent populates the directory utility in their second application with vendor contact information approved by the agent for use by connected homeowner's whose second application is linked with that particular agent second application.

6. The method of claim 1 further comprising the step of the first application automatically generating an email or text message to an agent alerting said agent that a homeowner referred that real estate agent via the second application with another homeowner whereby the email or text message has in its body the branding information and personal information of the partner connected to that agent.

7. The method of claim 1 further comprising the step of the first application automatically sending an email or text message to an agent alerting said agent that a homeowner has activated the second application on their mobile device or other computing device whereby the email or text message has in its body the branding information and personal information of the partner connected to that agent.

8. The method of claim 1 further comprising the step of accessing an agent's personal second application using a link to the second application on the dashboard of the agent's first application.

9. The method of claim 1 further comprising the step of automatic generation of an email or text message notification by the second application to the homeowner when a reminder comes due whereby said notification displays the personal contact and branding information of the agent.

10. The method of claim 1 further comprising the step of generating and automatically sending an email or text message by the second application when a homeowner electronically shares the second application with another homeowner whereby the agent thanks the homeowner and the branding information of the agent is contained within the text message or email.

11. The method of claim 1 further comprising the step of entering a custom reminder by a homeowner into the reminder utility of the second application.

12. The method of claim 1 further comprising the step of populating, by a homeowner, their directory utility of the second application with custom listings by inputting said listing information in the directory utility of the second application.

13. The method of claim 1 further comprising the step of electing to electronically share, by a homeowner, a directory listing that the homeowner has inputted into their directory utility of the second application with the agent from whom they received the second application by manually indicating on the directory utility of the second application.

14. The method of claim 1 whereby the first application automatically generates an email or text message alert to an agent alerting said agent that a homeowner has added a custom directory listing and has elected to share said directory listing for agent review and agent either approving or denying said directory listing for addition into the agent's directory listing and said email or text message alert containing the branding information of the partner connected to that agent.

15. The method of claim 1 further comprising the step of providing in-application notification alerts for newly added directory listings and reminders that have come due such that they are visible on the directory button and the reminders button on the second application dashboard.

16. The method of claim 1 further comprising the step of communicating to potential homeowners an offer of the second application via email or traditional mailings wherein said email or traditional mailings contain reference to a companion website whereby the homeowner can access said companion website and enter an access code provided in the email or traditional mailing into a field for receipt of the code on the companion website whereby once code entered, said companion website prompts the homeowner for their mobile telephone number and once said number is entered said companion website sends a text message to the homeowner's mobile with a link to contain activate and download and activate the second application and generation and sending of a text or email alert to the agent alerting them that a homeowner has entered their mobile telephone number and said text or email alert containing the branding information of a partner.

17. The method of claim 1 further comprising the step of placing agent selected and sponsored advertisements on the dashboard of the homeowner application viewable by homeowners.

18. The method of claim 1 further comprising the step of generating and sending an email or text message notification to a homeowner alerting them that a new directory listing has been added in the agent populated directory and displaying said directory listing information and the branding of the agent in the body of the email or text message.

19. A system for mutually benefitting a plurality of parties in the real estate industry using computing applications, comprising:
a first application downloadable to a partner and agent mobile device having a memory, processor, display and user interface and said first application connecting the partner and the agent by providing targeted communication from the partner to the agent via remote email and texting service upon the occurrence of an event favorable to an agent;
a second application downloadable to an agent and homeowner mobile device having a memory, process, display and user interface and said second application connecting the agent and homeowner by providing targeted communication from the agent to the homeowner via remote email and texting service upon the occurrence of an event favorable to the homeowner; and
executable code stored in a remote database communicating with remote servers that communicate with said first application and said second application and said remote servers utilizing remote email and texting services to send targeted communications to agents and homeowners whereby the branding of partners and agents is displayed in said targeted communications.

20. The system of claim 19 wherein the second application further comprises a directory utility and reminder utility.

21. A method for mutually benefitting a plurality of parties in the real estate industry using computing applications, comprising:
providing a first application downloadable and installable onto a mobile device or other computing device having a memory, processor, and display, said first application purposed for connection of an affiliate, partner or agent with other, affiliates, partners and agents;
providing a second application downloadable and installable by a homeowner onto a mobile device memory or other computing device having a memory, processor and display whereby said second mobile application is purposed for generating touches by an agent on a plurality of homeowners and aiding a homeowner in the maintenance and upkeep of their home;
benefitting a partner by creating touches with agents whereby an agent will have a partner's branding information displayed on a dashboard of their installed first application to keep a partner in the front of an agent's mind for referrals of future business;
benefitting an agent by through displaying the agent's branding information on a dashboard of homeowner's installed second application such that the homeowner repetitively sees the agent's branding information a plurality of times within a period of time to generate home sales and future clients; and
benefitting the homeowner by providing the homeowner a utility located on a dashboard of the second application displayed by the mobile device or other computing device that aids the homeowner in the maintenance and upkeep of their home.
